(19) United States
(12) Patent Application Publication
(10) Pub. No.: US 2007/0260737 A1
(43) Pub. Date: Nov. 8, 2007

(54) Method and system for the creation of service clients

(75) Inventors: Jose Gomes, Douglaston, NY (US); Paolina Centonze, Yorktown Heights, NY (US); Sai Zeng, Hawthorne, NY (US); Man Mohan Singh, Yorktown Heights, NY (US); Ioana Boier-Martin, Hawthorne, NY (US); Laurent Balmelli, White Plains, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/408,184

(22) Filed: Apr. 21, 2006

(51) Int. Cl. G06F 15/16

(52) U.S. Cl. 709/229

(57) ABSTRACT

A computer-implemented method (and structure) for creating a service client for a service and a role includes exercising an application programming interface (API) of the service to perform activities of the role, discovering data and behavioral models exposed by the service during this exercise, and configuring a selected set of graphical user interface (GUI) components to represent the discovered data and behavioral models for the activities of the role.

### FIELD OF THE INVENTION

This invention relates generally to the development of graphical user interfaces, and more specifically, the semi-automatic creation of graphical user interfaces in the context of Web Services.

### BACKGROUND OF THE INVENTION

A typical web service environment 100 for which the present invention is addressed is shown in FIG. 1, wherein a server 101 provides a portal for user 103 to access database 102 via the Internet 104. Server 101 executes one or more Service (Application) 105, each having its respective Application Program Interface (API) 106 that serves as the interface between the user 103 and the database 102. Interactions of user 103 with the service 105 typically occur through a graphical user interface (GUI).

However, conventional GUIs of computer-based enterprise applications are subject to a number of limitations, including, for example, that they do not support an automated run-time discovery of data models of the data transmitted between the server and the client. That is, the conventional development methods for GUIs of computer-based enterprise applications rely on knowing use-cases and data models at development time so that the GUI components may be selected, configured and laid out during a preliminary enterprise application development period, rather than at runtime. This is an important limitation when use cases and data models are subject to change during operations, as becomes more commonplace in web service environments.

Thus, the present inventors have recognized that a need exists to address the problem of creating, in a cost effective way, graphical user interfaces in the context of a large number of distributed applications, such as web services, such that these interfaces can be easily implemented in response to the various needs and changing conditions presented by these environments without the specialized design effort typical of conventional user interface development.

### SUMMARY OF THE INVENTION

In view of the foregoing and other exemplary problems, drawbacks, and disadvantages of the conventional methods and structures, it is an exemplary feature of the present invention to provide an efficient method to create a user interface for service clients.

It is another exemplary feature of the present invention to provide a method to configure graphical user interfaces during the runtime phase of web enterprise applications.

It is another exemplary feature of the present invention to provide a structure and method for creating graphical user interfaces for distributed applications available on the Internet.

It is another exemplary feature of the present invention to provide a method for developing user graphical interfaces in Web Services where encapsulation and polymorphism are used.

In a first exemplary aspect of the present invention, to achieve the above features, described herein is a computer-implemented method for creating a service client for a service and a role, including exercising an application programming interface (API) of the service to perform activities of the role; discovering data and behavioral models exposed by the service during this exercise; and configuring a selected set of graphical user interface (GUI) components to represent the discovered data and behavioral models for the activities of the role.

In a second exemplary aspect of the present invention, also described herein is a programmable storage medium tangibly embodying a program of machine-readable instructions executable by a digital processing apparatus to permit a user in a customizer role to perform the method of creating a graphical user interface in accordance with the previously-described method.

In a third exemplary aspect of the present invention, also described herein is a system for creating a graphical user interface of a target remote software application for a target user role, including a software module of instructions providing a user interface so that a user serving as a customization role can exercise an application programming interface of the target remote software application to perform activities of the target user role, discover data and behavioral models exposed by the target remote software application during this exercise, and configure a selected set of graphical user interface components to represent the discovered data and behavioral models for the activities of the target user role.

### BRIEF DESCRIPTION OF THE DRAWINGS

The foregoing and other purposes, aspects, benefits, and advantages will be better understood from the following detailed description of an exemplary embodiment of the invention with reference to the drawings, in which:

FIG. 1 shows exemplarity an environment 100 of conventional computer-based enterprise applications, each application having the requirement that a customized GUI has been developed as part of the development of the application;

FIG. 2 shows exemplarity the environment 200 of the present invention, wherein a customization role 202 allows development for a user interface for end-users 203, including such development during the runtime phase of the service;

FIG. 3 shows an exemplary process 300 of the present invention, wherein the customization process 301 provides a user interface for end-users 203;

FIG. 4 shows a software application client tool (SACT) 400 of the present invention that exemplarity permits the development and configuration of user interfaces utilizing the customization role 202;

FIGS. 5-40 exemplarity show various views and interactions that might occur during a typical customization role session, using the exemplary SACT 400 of the present invention to provide the canvas for configuring a user interface, and demonstrate the capabilities and concepts of the present invention, including the concept of exercising an Application Programming Interface of a service;

FIG. 41 illustrates a typical hardware configuration 4100 which may be used for implementing the system and method according to the exemplary aspects of the present invention; and

FIG. 42 illustrates programmable storage medium 4200, 4202 tangibly embodying a program of machine-readable instructions executable by a digital processing apparatus to perform the method according to the exemplary aspects of the present invention.

### DETAILED DESCRIPTION OF AN EXEMPLARY EMBODIMENT OF THE INVENTION

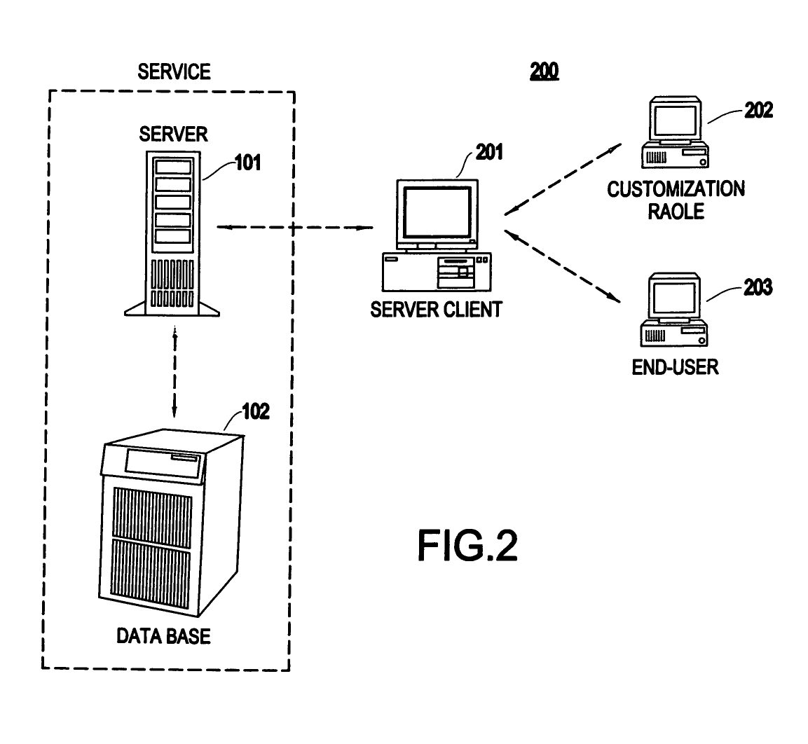

Referring now to the drawings, and more particularly to FIGS. 2-42, an exemplary embodiment of the present invention will now be described.

The present invention results from efforts to overcome the above-described problems of conventional development methods for GUIs of computer-based enterprise applications. With the increasing popularity of distributed applications available on the Internet, the problems of each specific tool become more apparent.

The paradigm of Web Services is becoming the de facto integration standard for distributed applications deployed on global networks. Prior to the present invention, the conventional methods have been deficient in addressing challenges associated with creating graphical user interfaces for Web Services applications. More specifically, these challenges are associated with two aspects of Web Services, encapsulation and polymorphism.

First, the fast proliferation of services, user roles, and users on the global networks makes it increasingly difficult to produce graphical user interfaces rapidly enough and in a cost effective way. Encapsulation, which is the insulation of the structural and behavioral properties of an application from the rest of the environment, or “universe”, has allowed creating robust and proven services, and the resulting scalability, together with the popularity of the paradigm, has favored this proliferation. However, the services providers, i.e., the organizations that provide services, are themselves limited in their ability to provide graphical user interfaces to their customers, or service consumers, by their inability to identify the end-users of their services, their lack of knowledge of the potential usage scenarios of their services, in particular, the potential many ways in which their services may be repurposed and composed with other services to create new services.

Second, polymorphism, which means allowing a single definition to be used with different objects (or messages) of different types, makes it difficult for service providers to predict what actual types will be used in conjunction with their services and, therefore, complicates the task of creating graphical user interfaces that will fit all needs. This is particularly the case with class inheritance (or extensions of message schemas), since service providers have no control over what actual subclasses of classes (or extensions of message schemas) referenced by the application programming interface may be defined, instantiated and provided as inputs to their application programming interface.

The present inventors have recognized that a need exists to address these problems of creating, in a cost effective way, graphical user interfaces in particularly the context of a large number of distributed applications that make heavy use of encapsulation and polymorphism. The present invention describes such a method additionally providing the benefit that user interfaces can be developed during runtime. In summary, this method provides a mechanism in which a first user, serving in a customization role, is provided with a tool so that the application API can be exercised specifically for the purpose of configuring interface components and events in the manner typical of that an end-user. This package of configured components can then saved as a user interface package, available for subsequent users categorized in a second role, the end-user role.

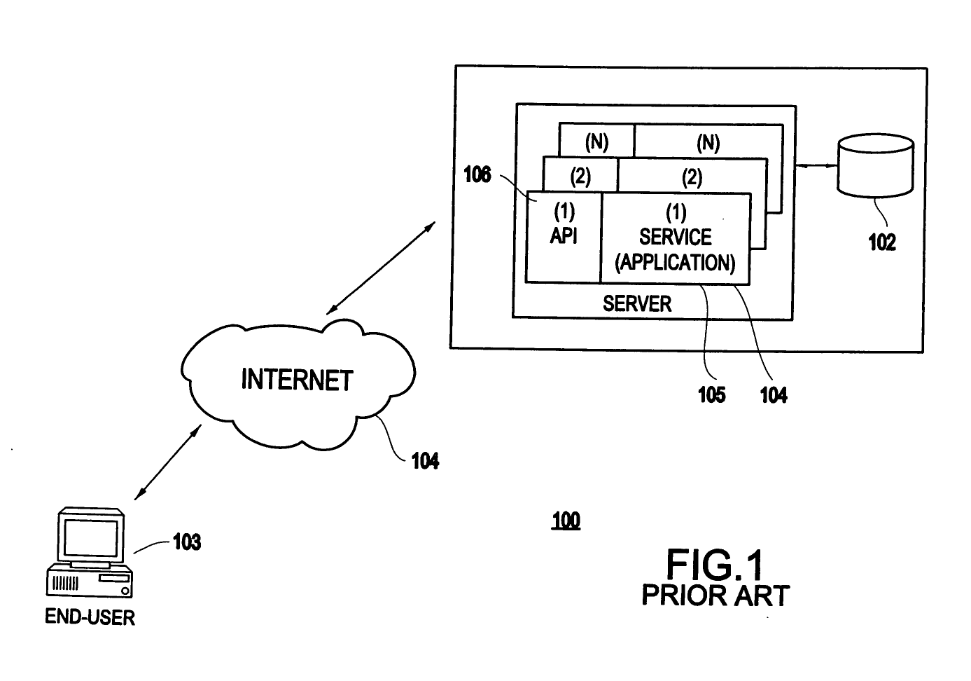

FIG. 2 illustrates exemplarity some differences of the present invention from the architecture shown in FIG. 1, to provide the advantage of efficient development of user interfaces. Although not specifically shown in FIG. 2, server 101 includes at least one application, each with its respective API, as previously shown in FIG. 1. Service client 201 can be consider as part of the service, or remotely located. The service client 201 of the present invention provides two types of user roles: a customization role 202 for discovering behavioral and data models of an application, which process is used for configuring user interfaces (e.g., UIs), and, an end-user role 203 that utilizes the UI developed by the customization role. These UIs correspond to the conventional GUIs that are commonly laid out during the initial development phases of the service and not readily available to be configured during runtime phase of the service.

With this background, to further explain the concepts of the present invention and, given the exemplary environment and architecture shown in FIGS. 1-2, the following definitions are provided.

Definitions

Service (or Application) denotes a software application exposed to a network by a server and accessible through its Application Programming Interface (API).

Service Client denotes a graphical user interface (GUI) application used by users to use services by exercising their APIs.

Service Operation denotes a function of a service exposed by the service API. An operation may have an input, an output and may also generate a “fault” typically containing an error message. The input may be a collection of objects (or messages) that the Service Client provides the service. The output may be a collection of objects (or messages), and may usually be obtained through a computation based on the input and other information. Invoking a service operation (or executing a service operation) may result in the Service Client or Service changing their states.

Service Data Model denotes the object-oriented data model (or message schemas) of the data exchanged between the Service and the Service Client. In this disclosure, a Service Data Model is not only associated with a specific Service but also to a specific Role because users in given roles may be using the service is such different ways as to expose service data differently. This is a consequence of polymorphism. In effect, the exact runtime types of objects (or messages) used as inputs and outputs may be dependent on use cases in the case of polymorphic service operations. This is not the case with non-polymorphic service operations, for which the exact types of the inputs and outputs at runtime are entirely predetermined by the service API.

Service Behavioral Model consists of the set of operations of the service together with their semantics, or expected behavior. In this document, a Service Behavioral Model is not only associated with a specific Service but also to a specific Role because users in given roles may be using the service is such different ways as to gain access to different service operations.

Role denotes, from one perspective, a specific set of permissions to exercise a service API, and from another perspective, the role (in the usual sense) of a person or organization using the service in the context of a set of business processes. By an abuse of language, the two definitions will be confounded because, to fulfill a specific role in an enterprise, a person or organization needs to be granted a specific set of permissions.

Work Session denotes the sequence of operation invocations, including the data supplied to, or obtained by, these invocations, as performed by a user in a given role while accomplishing a complete task. One way to think of a work session is as a hierarchical stack of operation invocation. Indeed, the invocation of an operation of the service may result in obtaining a new service of which operations can be invoked as well. This recursive pattern may naturally be represented in a hierarchical data structure (a tree).

Service Client Customization denotes the possibility for a user in a given role to alter the appearance of the Service Client according to the Service Data Model and to alter its interactive features (actionable items such as buttons) according to the Service Behavioral Model as appropriate for this Role.

GUI Component denotes a graphical widget, interactive or not, that may be laid out together with other graphical widgets to form the Service GUI. GUI Components may be used to visually represent data, to enter data, or trigger the invocation of an operation or method. GUI components are typically configurable, in particular their appearance and behavior may be adjusted to best represent data or implement a desired interactive feature.

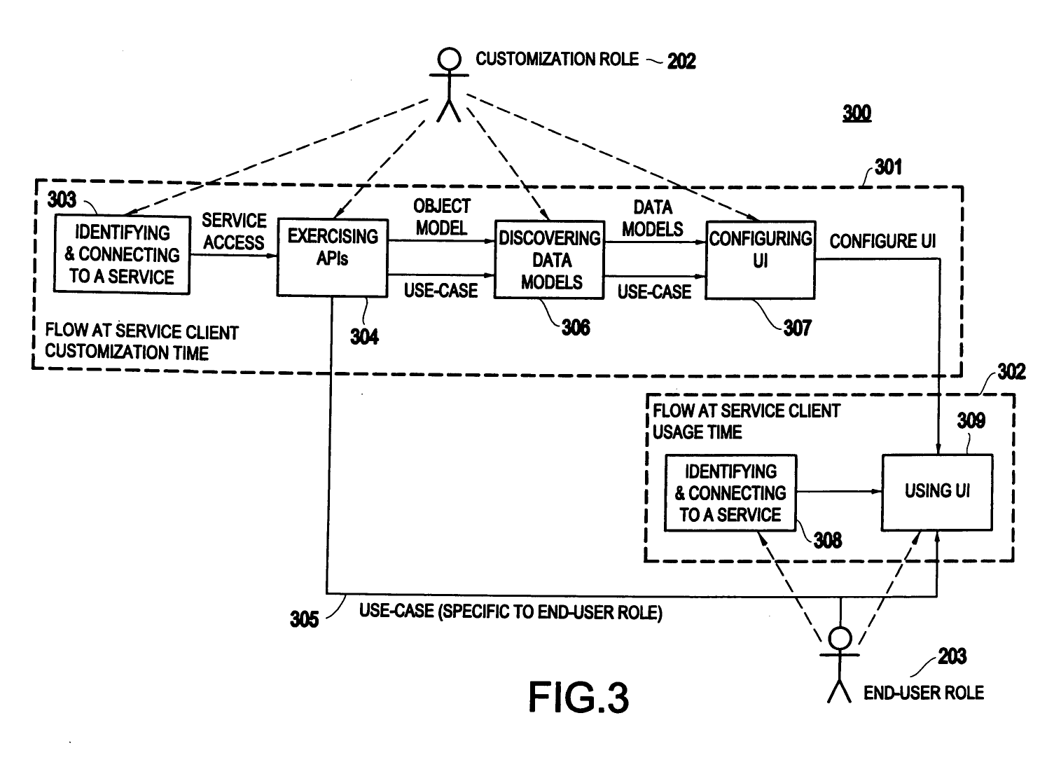

FIG. 3 exemplarity illustrates the process 300 of the present invention for the two distinct roles of customization 202 and end-user 203. The upper process 301 shows the steps for the customization role 202 and the lower process 302 shows the steps for the end-user role 203. More specifically, during customization 301, the user in a customization role identifies and connects to a service and accesses the service in step 303. In step 304, use-cases specific to an end-user role are used as inputs 305 for exercising the service API for discovering, in step 306, the service behavioral models and, in step 307, for configuring the UIs to be available for use by the end-user role 203 in a service client usage steps 308 and 309.

With this method and the software tool utilized to implement access to the application for purpose of developing a user interface, the present invention provides a mechanism by which the conventional GUI can be developed during runtime and in rapid response to new end-user roles that might arise over time for the service. A number of figures presented shortly demonstrate this customization role 301, using an exemplary software application tool developed as one aspect of the present invention for the UI customization process.

However, in spite of the many details shown in this specific example and the figures, it should be clear to one having ordinary skill in the art, after taking this disclosure as a whole, that the present invention presents a more generic concept of demonstrating a service client customization role, during which customization role a user interface is efficiently and rapidly configured by exercising the service API to discover the data models of the service.

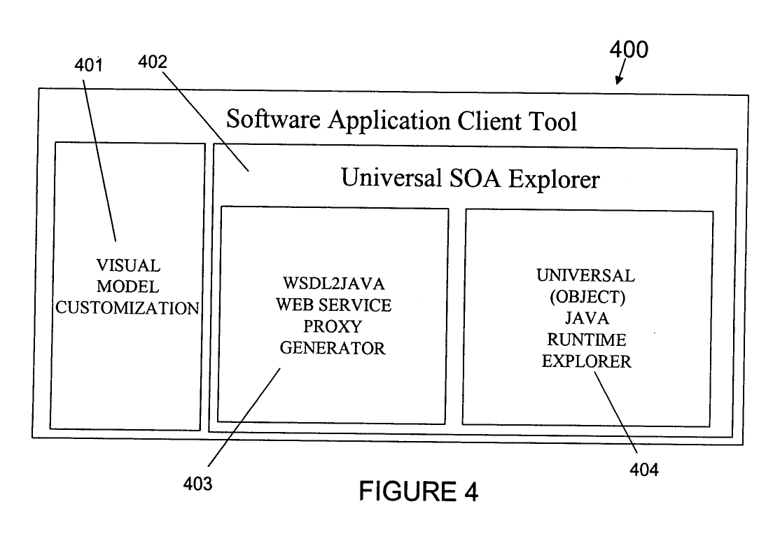

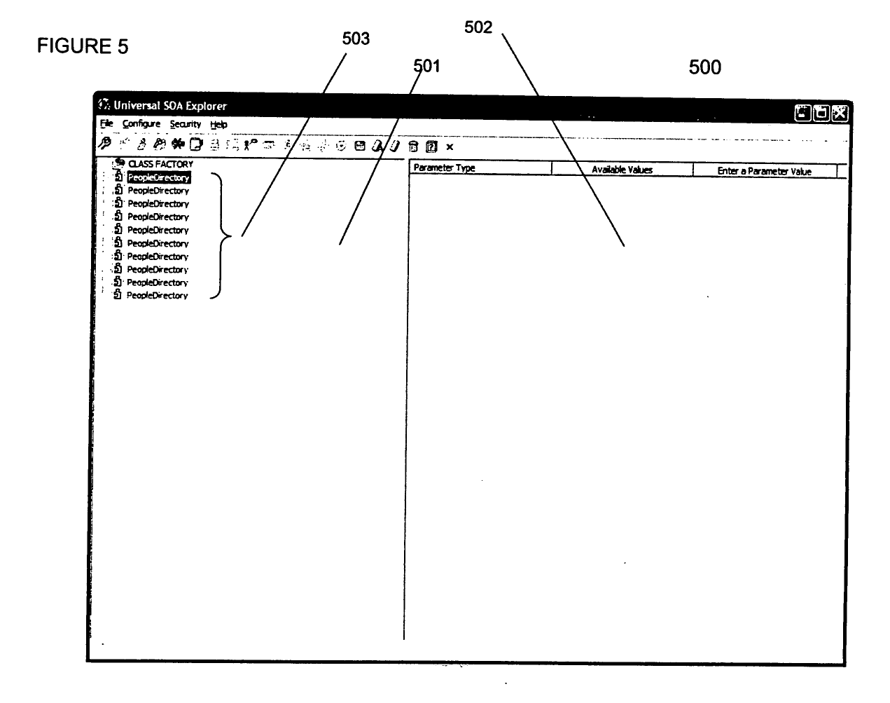

As one exemplary mechanism used to implement this novel customization role of the present invention, FIG. 4 illustrates subcomponent modules of the Software Application Client Tool (SACT) 400 through which the customization role has been achieved and provided the exemplary process steps illustrated in FIGS. 5-40. The SACT 400 includes a Visual Model Customization module 401 and a Universal Service Oriented Architecture (SOA) Explorer module 402.

The explorer module 402 is further comprised, in the exemplary embodiment wherein Java is used to implement the concepts of the present invention, of a WSDL2JAVA Web Service Proxy Generator module 403 and a Universal (Object) Java Runtime Explorer module 404. Although the present invention has been exemplarity embodied using Java and the exemplary system architecture shown in FIGS. 2-4, it is not limited to this specific implementation or the details therein, since the concepts are clearly more generic.

The exemplary Software Application Client Tool (SACT) shown in FIG. 4 is a Graphical User Interface utility that can act as a client to, in this exemplary embodiment using Java, a variety of Java Application. The SACT allows loading classes, constructing objects, and invoking methods on those objects. The SACT is applicable to any application object.

The SACT does not depend on any specific architecture, and the objects that it manipulates are just regular Java objects, including, but not limited to, any Web Services and SOA application objects. The SACT allows monitoring the lifecycle of any complex object that it manipulates.

Moreover, the SACT offers contextual persistence of the visual model associated with each class customization, not only throughout the execution of a SACT session, but even throughout executions of different sessions. The SACT displays the execution of an application as a Functional Invocation Tree (FIT), which offers a graphical representation of the functional dependencies and relations between objects, as will be demonstrated in the various exemplary figures that demonstrate an exemplary scenario of configuring a user interface.

From a security point of view, the SACT offers:

(1) Local-system integrity protection by allowing an administrator to precisely specify what actions the code being executed in the SACT is permitted to do. This access control feature is fine grained. For example, it is possible to assign permissions to code and the permissions can be very specific, such as reading one file but not another, etc. This feature is an extension of Java 2 security and bases permission assignment on the location from which the code is coming as well as the entities that digitally signed the code.

(2) Role-Based Access Control (RBAC) by restricting access to:
the visual model associated with each class customization; and
the functions in the application that can be invoked.

Access restrictions are based on the roles that have been assigned to the user. To achieve this task of restriction, the SACT can have a user authentication feature.

The SACT has introspection capabilities that allow it to detect information about the objects it manipulates, such as the names of the parameters of a method. Additionally, if such information is not available, the SACT allows source-code-based introspection and, in cases where source code is not available, manual introspection customization.

The SACT manipulates objects and displays them in the FIT, a structured, hierarchical view that allows identifying and keeping track of relations between objects. The SACT allows a user to specify precisely what information about an object needs to be displayed but does not restrict its use to specific objects, such as SOA application objects or Web services. Rather, the SACT allows a user to explore, monitor, and inspect any Java application and the objects that are manipulated by that application.

To do this, the SACT has a very thin layer called Visual Model Customization (VMC) 401. The VCM allows customizing which functions of an object should be invoked, as well as what information about the object itself, and the results of those functions should be displayed.

Specifically, VCM reports all the functions that can be invoked on an object, based on the object's type. VCM distinguishes the functions that display an object's state (called “state-display methods”) from those that can be used to manipulate the state of the object and modify the object's behavior (called “action methods”). All objects of the same class will share the same configuration. A class configuration consists of two sets: the set of the state-display methods of interest, and the set of the action methods of interest. For each method in a configuration, the user can choose what about the result of that method invocation will be displayed in the FIT.

For example, the user can choose to display a string representation of a returned object or, for collection-like objects, the single elements held by the object. Among the state-display method, the user can choose one that offers a better representation of the object in the FIT. Configurations are persistent throughout an execution of SACT or even throughout different executions.

Once objects are displayed in the FIT, the user can invoke the configured methods on those objects. The SACT uses Java reflection to perform method invocations. This allow SACT to be general and work with any run-time object. This component of the SACT is known as the Universal Java Runtime Object Explorer (UJROE) 404. SACT can also act as a Universal Service Oriented Architecture (SOA) Explorer (USOAE) 402. This is possible because the UJROE component is integrated with a WSDL2Java Web Service Proxy Generator component 403, which can be used to automatically generate a proxy from a local or remote WSDL (Web Services Description Language) file and subsequently invoke remote Web services through the generated proxy.

Since method invocations may require complex objects as parameters (not just strings and scalars), SACT allows for the construction and manipulation of complex objects as well.

State-displayed methods are invoked automatically and the results of those invocations are shown. Action methods need to be explicitly invoked by the user because they could take complex objects as parameters. Therefore, the user can build new invocations of action methods. For each invocation, the user can choose which parameter values to pass to the invocation based on all the objects that have been constructed so far and whose type is compatible with the parameter types.

Each invocation is uniquely identified by an object receiver, a method, and parameter values passed to the invocation. An invocation will also contain a result value (which could be an exception) and an invocation context that describes the context under which the invocation was performed (such as the date and time). Invocations are persistent throughout the execution of SACT. If a new invocation is performed that, as a side effect, alters the value of a previous invocation, that value is not refreshed unless the user specifically selects an automatic-refresh option or explicitly re-performs that previous invocation. This is an important feature which, coupled with the invocation context, allows for object lifecycle monitoring.

From a security point of view, SACT offers local-system protection by allowing, restricting, or permitting access to local system resources. Access control is fine grained because it is possible to explicitly declare which resources can be accessed and the mode of access. This type of access control is based on the location from which the code is coming, as well as the digital signatures on the code.

SACT offers user authentication and RBAC. Specifically, SACT uses the authentication information to limit access to the VCM and to the application object functions.

The VCM is integrated with an innovative and enhanced introspection capability. SACT has the ability to examine meta-configuration files (such as WDSL files for Web services) to detect information about the code being executed that would not be otherwise available. If meta-configuration files are not available, SACT can inspect the application's own source code or, in the case in which source code is not available either, SACT allows for manual introspection customization.

Thus, the present invention allows discovery of the Service Data Model by exercising the API to learn the exact types of objects (or exact schemas of messages) returned by service operations, since these types may not be known from inspecting the Service API in the case of polymorphic operations.

In another exemplary aspect of the present invention, discovering the Service Data Model and the Service Behavioral Model includes using various API inspection mechanisms (such as reflection or introspection) to learn about the structure and behavior of a service or object (or message) involved in its data model.

In another exemplary aspect of the present invention, the Service Client Customization includes selecting a set of GUI Components judged appropriate to represent the discovered Service Data Model and the Service Behavioral Model, laying out these GUI Components, and configuring them.

In another exemplary aspect of the present invention, an exemplary GUI Component displays an interactive graph of nodes representing Service Data Model elements and Service Behavioral Model elements. The customization of this GUI Component may include selecting which classes of objects (or which message types) are visible, which elements of these objects (or messages) are visible and adjusting the appearance of the visual representation of the selected items. In yet another exemplary aspect of the present invention, the exemplary GUI Component introduced above also includes to represent a Work Session as a tree.

All of the above-mentioned exemplary aspects will be better understood with the following additional discussion. First, it was noted that the Customization Role exercises the API of the service in the context of a use-case by invoking the operations of the service in a sequence dictated by the use case. The inputs provided to the operations are either dictated by the use case itself or are the outputs of other operations invoked during this exercising. The objective of this step is for the Customization Role to discover the data model and behavioral model of the service in the context of this use-case and use this information to design the GUI.

For example, a simple use-case could consist of searching a personal record based on partial identify information and then, once a record is uniquely identified, accessing specific informational fields of this record. In this example, exercising the service might comprise invoking two operations such as search( ) and retrieve( ). Search( ) will take as input a search criterion such as a partial name and the output will be a list of personal identifiers matching the search criterion. Retrieve( ) would then take as input one specific personal identifier and the name of a field to retrieve, such as the address of the individual.

During this exercising, the Customization Role will, for instance, discover the format of the personal identifiers and informational fields returned by the service and will be able to make decisions on how to represent them in the GUI. The use-cases addressed by the Customization Roles would typically, therefore, inherently be representative of the needs of the end-user roles of the created GUI.

The remaining section illustrates these ideas by applying the method to the creation of a Service Client for a hypothetical Service. FIG. 5 shows an exemplary display 500 of the Universal SOA Explorer 402 previously discussed relative to FIG. 4. This display and its associated menus and tools permit the customization role to explore a service API and configure the end-user interfaces of the present invention. FIGS. 5-40 will show various aspects of the exemplary SACT implementation of the customization role, as demonstrated in the following exemplary customization scenario.

Illustration of a Service.

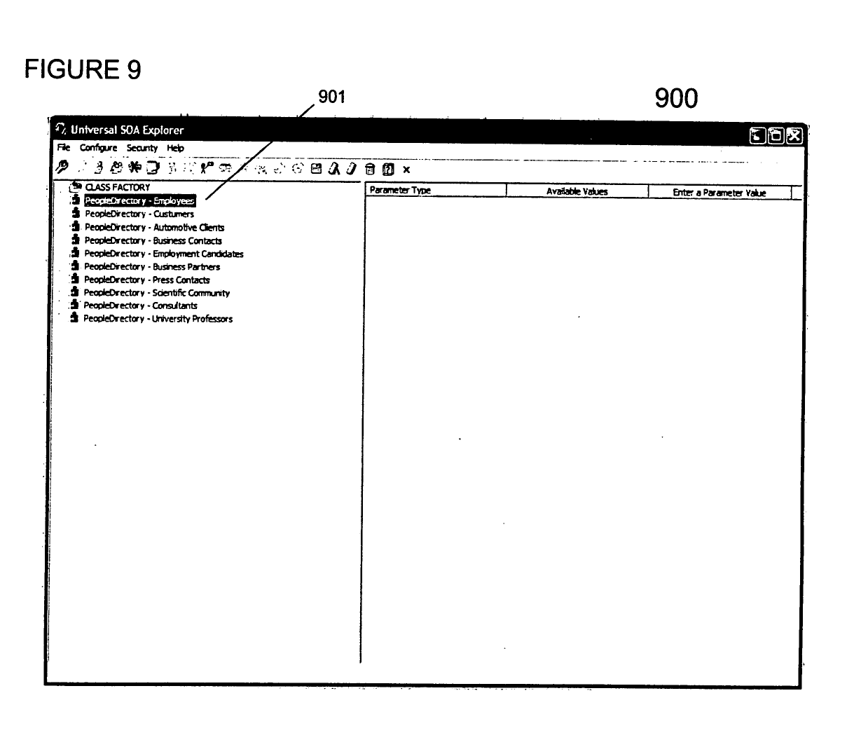

An exemplary hypothetical Service, called “PeopleDirectory”, that allows authoring, searching and browsing repositories of personal records, will be used. Each such record is represented as an object of the class Person (or a message with the schema Person), or of any subclass of it (or of any extended schema of it). The ““PeopleDirectory”” service may be used to manage repositories of employees, customers, or any application, as exemplarity shown in FIG. 9 to be discussed later.

Illustration of a Service Client.

A ““PeopleDirectory”” service client may be used to author, search or browse objects of the class Person or of subclass of the class Person (or messages of the schema Person or of any extended schema), as demonstrated in FIG. 9 to be discussed later. For instance, the polymorphic service operation “add(Person)” may accept as valid argument any object of the class Employee, if that is a subclass of the class Person (or any message of the schema Employee) if that is an extended schema of the schema Person). Per the method of this invention, a ““PeopleDirectory”” Service Client is created by assembling and configuring a selected set of GUI Components that will represent the data model and behavioral model of the “PeopleDirectory” service most appropriately from the perspective of a given role.

Illustration of a Role.

For the sake of illustration, it is assumed that the “PeopleDirectory” Service adopts a Role-Based Access Control security model. The example will focus on a role called Reader, who is granted all the permissions required to search and browse any personal records of a personal records repository. The following sections illustrate the creation of a “PeopleDirectory” Client Service for the Reader role. Indeed, this role is naturally associated with a set of use cases that need to be supported by the resulting Client Service. Another role, such as Administrator, would possibly be associated with other use cases and would possibly command a different Service Client.

Illustration of a GUI Component

Per the method of this invention, a Service Client is created by selecting, laying-out in a graphical interface canvas, and configuring GUI Components according to the Service Data Model and Service Behavioral Model, as perceived by a user executing use cases associated with a given Role. As users in a specific Role discovers the Service Data Model and Service Behavioral Model associated with it, they will select from a library the most appropriate GUI Components (i.e., buttons, labels, trees, tables, diagrams, menus) that are most appropriate to represent data and to operate the service.

For the sake of illustration, one such GUI Component is an interactive graphical component called a Session Tree that simply represents the Service Data Model and Service Behavioral Model as a highly configurable tree of interactive objects.

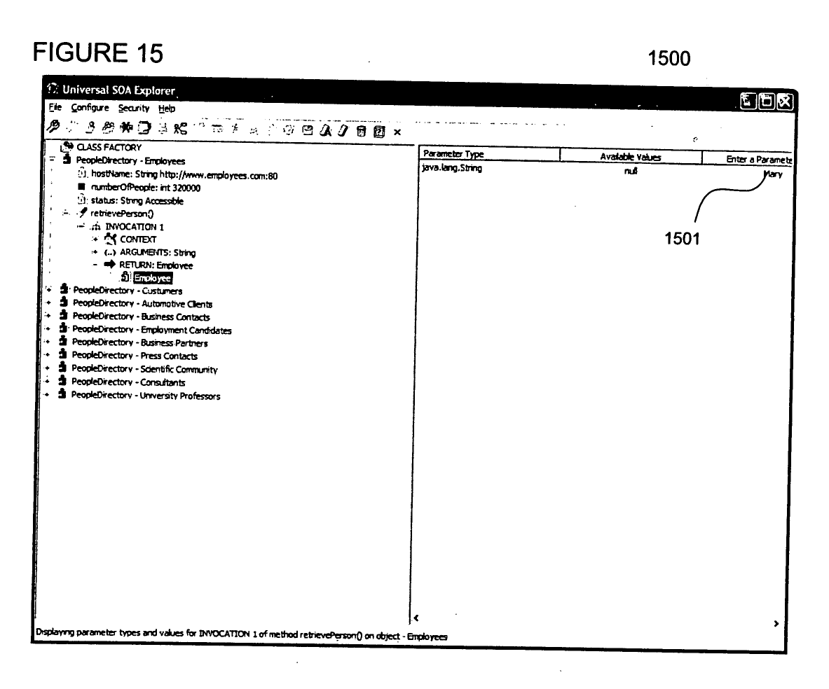

The top level node of a Session Tree represents the Service itself and children objects represent either properties or operations of the Service, as can be seen, for example, in FIG. 15 (discussed later). The children objects representing Service operations are interactive and allow users to invoke the operations.

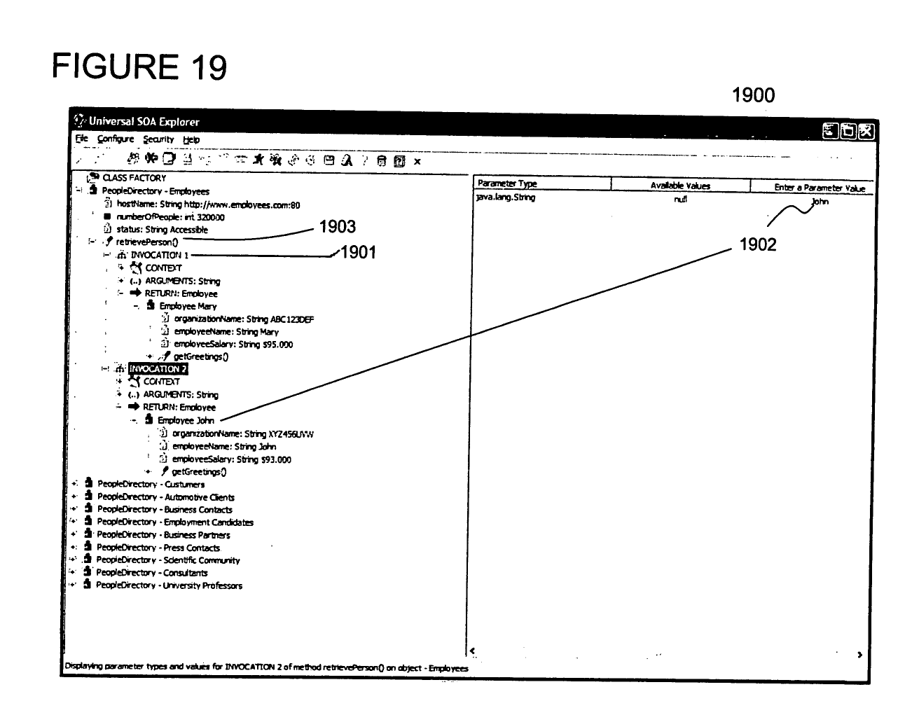

Since an operation may be invoked multiple times, each invocation is represented as a child object of the operation. Each invocation being associated with the set of arguments to use and with the object returned, or possibly the exception thrown, each of these objects are represented as a child object of the invocation object, as can be seen, for example, in FIG. 19 to be discussed later.

Similarly, any object returned by an invocation of a service operation has its properties and methods represented as children of its own. Consequently, the hierarchy of service operation and operation invocations can simply be represented as a tree. In this illustration, this tree is called the Session Tree because it captures all the actions performed by a user during a session, as well as their outcome, i.e. the objects returned by invoking Service operations or object methods, as can be seen in, for example, FIG. 19 to be discussed later.

Illustration of Service Client Customization

As users discovers the Service Data Model and Service Behavioral Model associated with its Roles, and after selecting the most appropriate GUI Components to use to represent them, they may need to customize their appearance or behavior. A trivial example of customizing a button is selecting its shape and color and selecting whether the associated action is performed when the button is pressed or released.

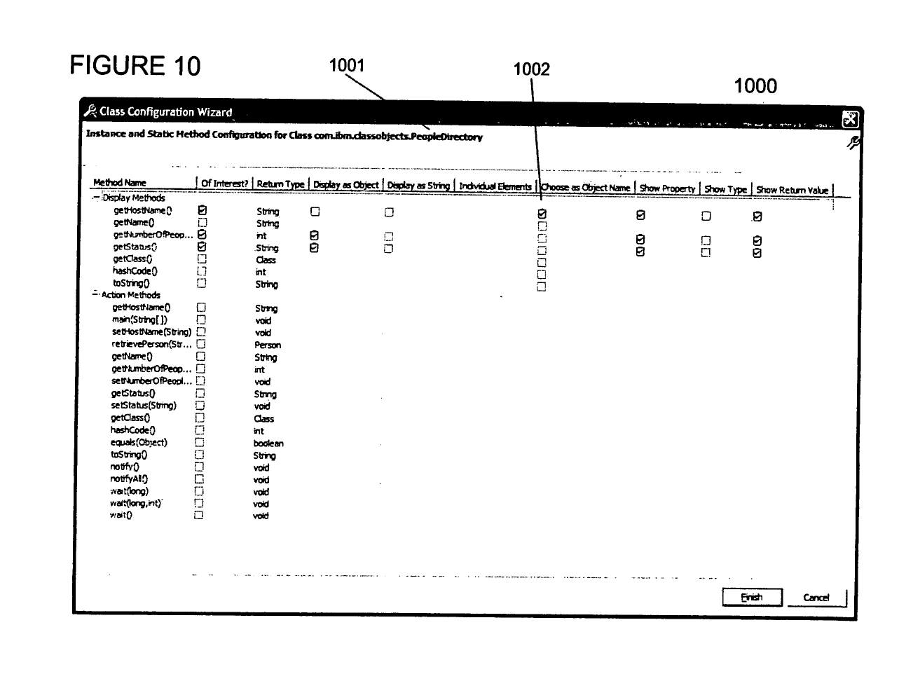

For the sake of illustration, customizing a Session Tree consists of selecting which objects of the Service Data Model are to be display and not hidden, configuring the appearance of the selected objects (icon, label), selecting which of its properties and methods are to be visible, selecting a policy for operation invocation (for instance, an operation may be invoked automatically periodically, automatically whenever the inputs specified by the use have changed, or manually by a predetermined user action), as can be seen, for example, in FIGS. 10, 14, and 16 to be discussed later.

The Session Tree is customized on a per class basis (or per schema basis), meaning that all objects of a common class (or all messages of a common schema) share the same individual customization and therefore their appearance and interactive behavior are the same.

For illustration, one may associate a specific icon to a specific class (or specific schema) and this icon is then used to represent objects of this class (or message of this schema) in the Session Tree. Alternatively, the class (or message) could be associated with a selection rule for selecting an icon based on the state of the object (or a state property of a message), such as Open or Close. Then, although two different objects of the same class (or messages of the same schema) may be shown with two different icons, they share the same customization rules.

The per-class customization of the Session Tree also allows selecting which operations and which properties are made visible as children nodes in the tree.

Illustration of the discovery of Service Data Model and Service Behavioral Model

While performing a service client customization, it might be necessary to discover Service Data Model or Service Behavioral Model elements by exercising the service API, and not relying on the service API documentation. As explained earlier, the exact runtime type of inputs and outputs to polymorphic operations may depend on a use case context. For the sake of illustration, the “PeopleDirectory” service may have a documented method called “Person retrieve(String identifier)” taking as input a unique personal record identified and returning an object of the class Person (or message of the schema Person). This characterization of this operation may be obtained by inspecting the documentation of the operation, or possible by an automatic discovery mechanism, such as reflection or introspection. However, this operation may be polymorphic in which case it is necessary to execute it in the context of representative use cases of a role to actually discover the exact runtime type of its output. For instance, the actual output of this operation could be of the type Employee, subclass of the class (or extended schema of the schema) Person, as can be seen, for example, in FIG. 15 to be discussed later. Since the structure of objects of class (or messages of schema) Person and Employee may be very different (although Employee is based on Person), this may have a significant impact on the Client Service.

Consistent with the flowchart shown in FIG. 3, as an exemplary demonstration of the concepts of the present invention, this section shows the creating of a Service Client for a given Role by exercising the Service API following use-cases of the Role, in order to discover the Service Data Model and the Service Behavioral Model actually exposed to this Role, and performing a Service Client Customization accordingly.

Specifically, the Customization Role is responsible for creating graphical widgets, while the End-User Role uses the created widgets in the context of a business process. It is important to note that the present invention teaches to exercise (or execute) the API, as exemplarity demonstrated by various figures to be discussed shortly. This concept of exercising the API contrasts with conventional methods for GUI creation that rely on the API documentation or API reflection mechanisms. The need to actually exercise APIs arises from the fact that composing services from other services includes composing polymorphic APIs and this may make it very difficult, or even impossible, to predict actual runtime object types (or message schemas) without exercising the composed APIs in their specific use case contexts.

Although the following discussion and figures provide an example to demonstrate the concepts of the customization role of the present invention, the present invention is not intended as limited by this example and these figures.

FIG. 5 illustrates a view 500 of a Client Service that has not yet been fully customized. The Client Service has been customized by adding two GUI components, a Session Tree 501 to the left hand-side and a property table 502 on the right hand-side. The Client Service is exemplarity shown as connected via the network to ten different “PeopleDirectory” services 503.

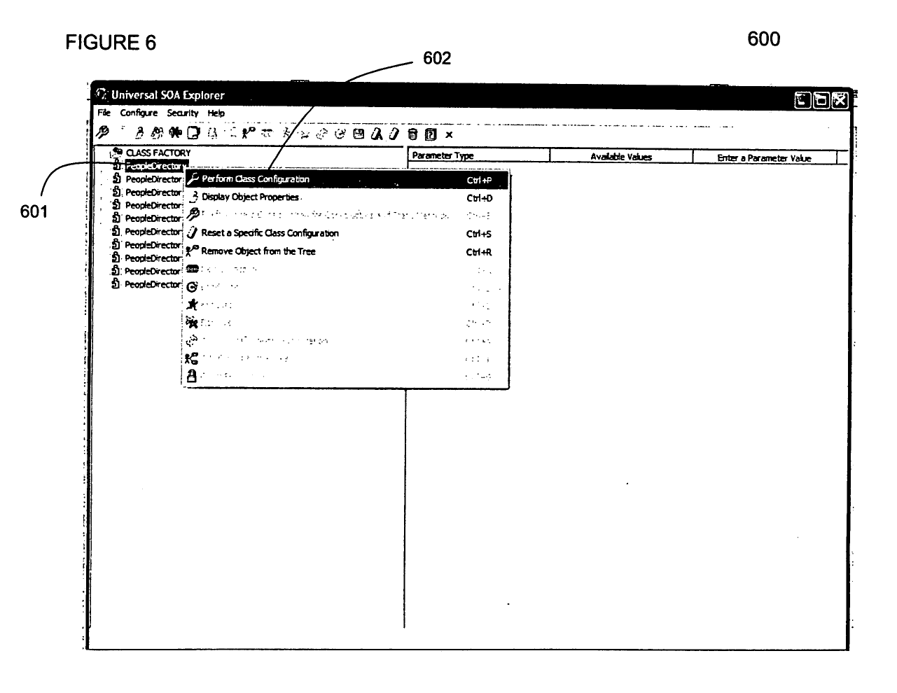

FIG. 6 illustrates a view 600 in which the user is selecting to configure the Session Tree GUI component by altering the way that “PeopleDirectory” services 601 are displayed and interacted with in the GUI Component. In this illustration, this customization is performed on a class-basis (or schema-basis) 602, which means that all “PeopleDirectory” services will be represented in the same way in the Client Service. This view 600 shows the ability of the tool to perform class configuration.

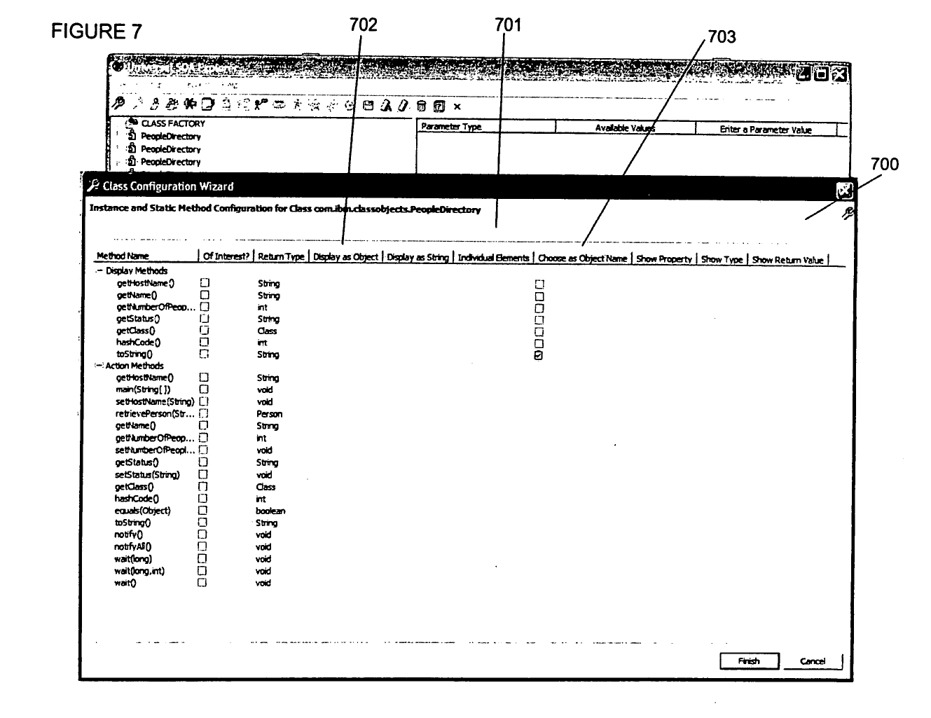

FIG. 7 illustrates a view of a class configuration wizard 700 for a service (in the specific example, the service is of the type “PeopleDirectory”). In this illustration, the service API is automatically discovered and summarized in an interactive table representation 701. In this representation 700, each service operation is associated with a table row. The non-editable columns of this table represent information pertaining to each operation, such as the documented types of the inputs and outputs, while the editable columns of this table are associated with a Session Tree customization feature. For instance, the fourth column 702 is used by the user to specify whether an operation should be made visible in the Tree Session, allowing the use to invoke it. By default, no service operation is visible. For instance, the seventh column 703 is used by the user to specify which service operation should be used to obtain a string to name a “PeopleDirectory” service node in the Session Tree, since the default string displayed for a service is simply “PeopleDirectory” and is not very informative.

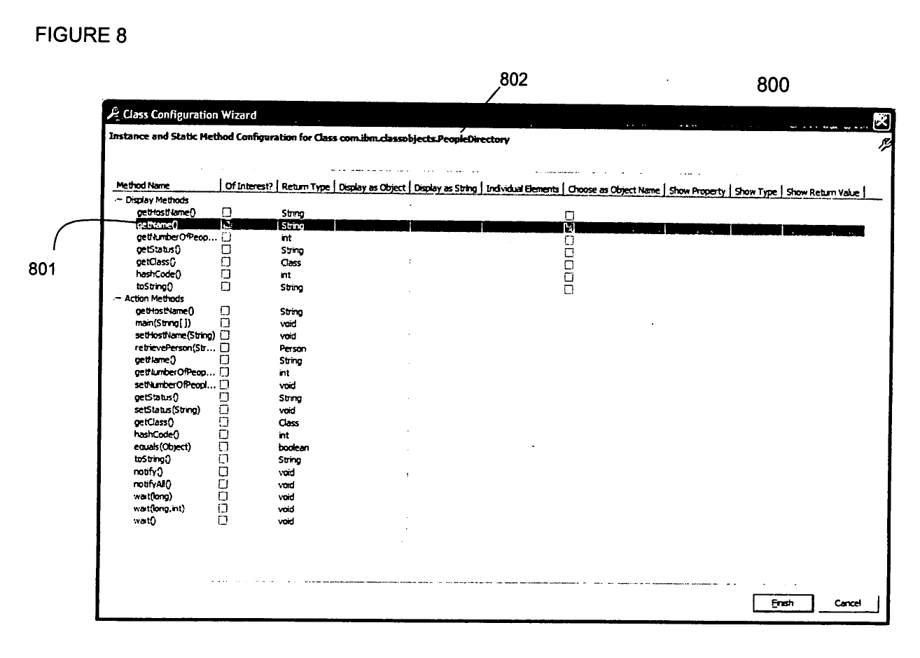

FIG. 8 illustrates 800 an exemplary configuration in which the user selects to use a service operation called “getName( )” 801 to name the “PeopleDirectory” service node 802 in the Session Tree. FIG. 9 illustrates an exemplary view 900 in which the display appearance of the nodes 901 in the Session Tree that were representing “PeopleDirectory” services were automatically updated to reflect the customization just performed (e.g., the return value of getName( ) operation just mentioned for FIG. 8.

FIG. 10 illustrates 1000 an exemplary configuration that allows selecting operations that may be used to obtain information about the service and choosing how the outputs these operations should be displayed. In this example, the name chosen for the PeopleDirectory objects 1001 now is the return value of getHostName( ) 1002.

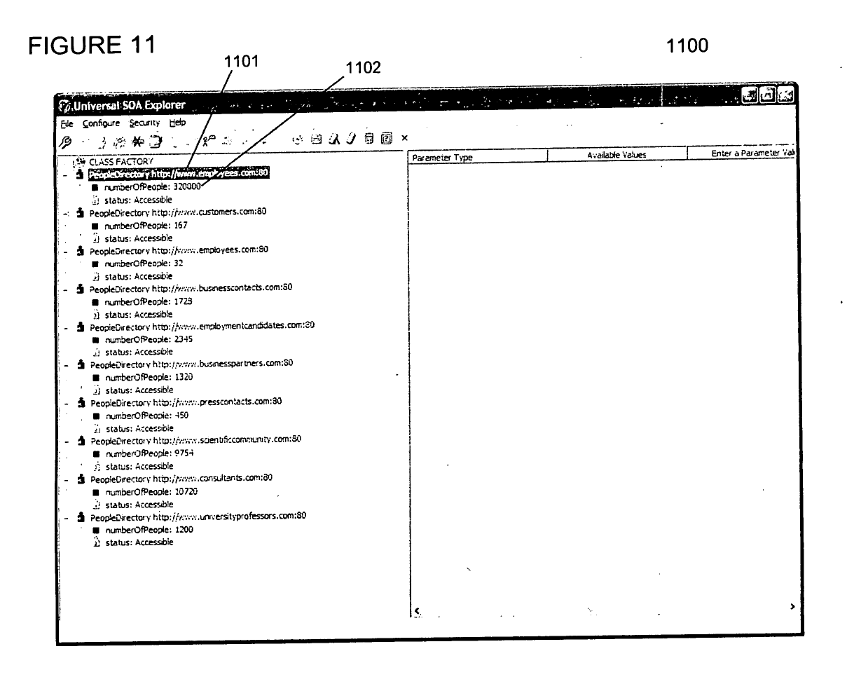

FIG. 11 illustrates an exemplary view 1100 in which all the visual appearance of the Session Tree nodes that represent “PeopleDirectory” services has been altered to display additional information 1101, 1102 about each service, as a result of the previous configuration shown in FIG. 10. It is noted that all the objects of type PeopleDirectory are configured at once and that the object name for object of type PeopleDirectory has changed accordingly.

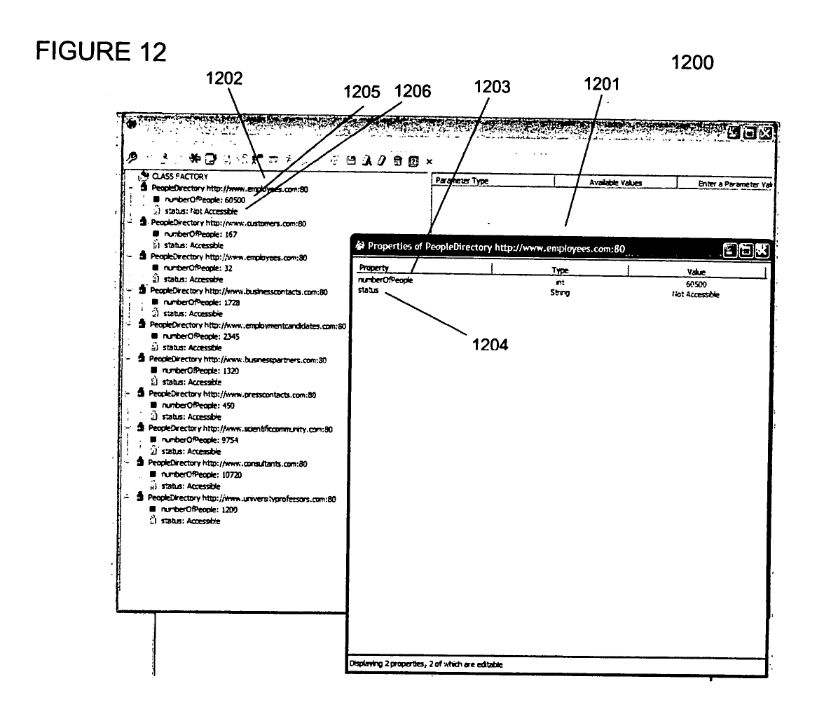

FIG. 12 illustrates another exemplary view 1200 displaying properties of Session Tree nodes, using the Property Window 1201 for the specific object PeopleDirectory://www.employees.com.80 to set its tow properties 1203, 1204. The changes are immediately reflected also in the tree for this specific object.

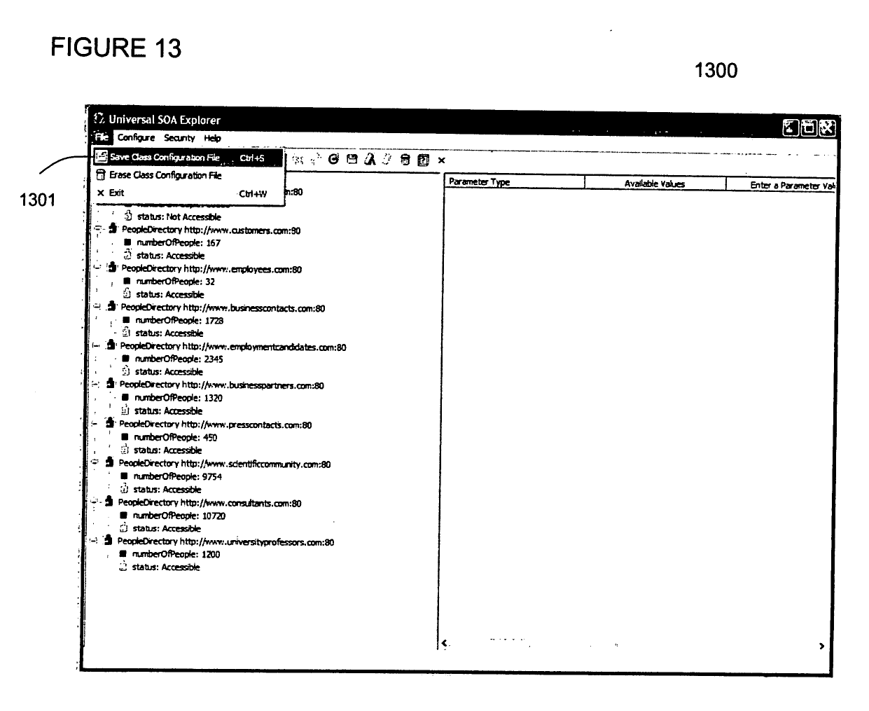

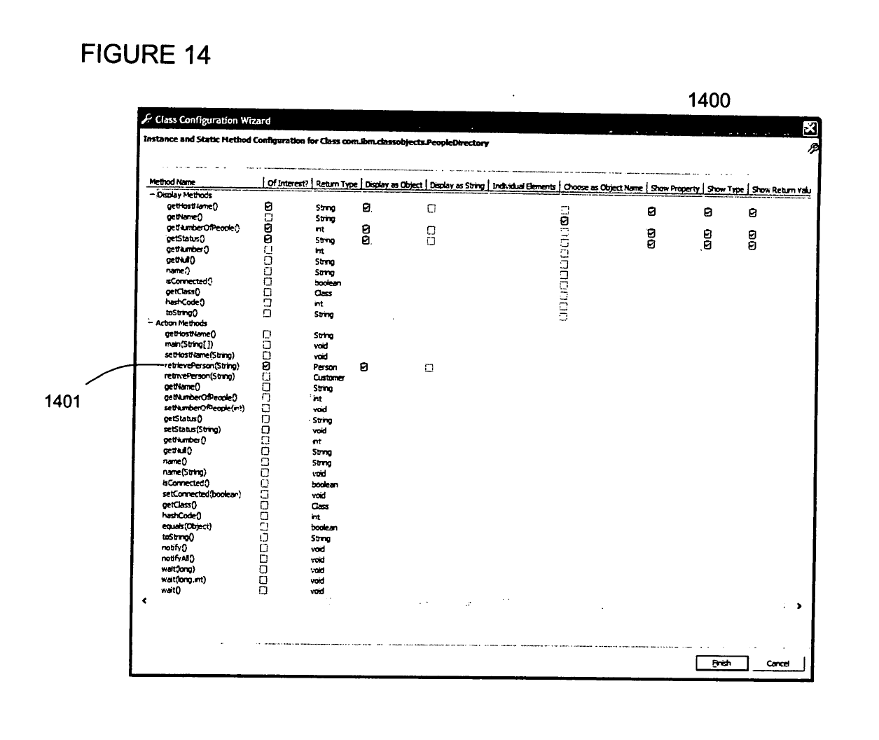

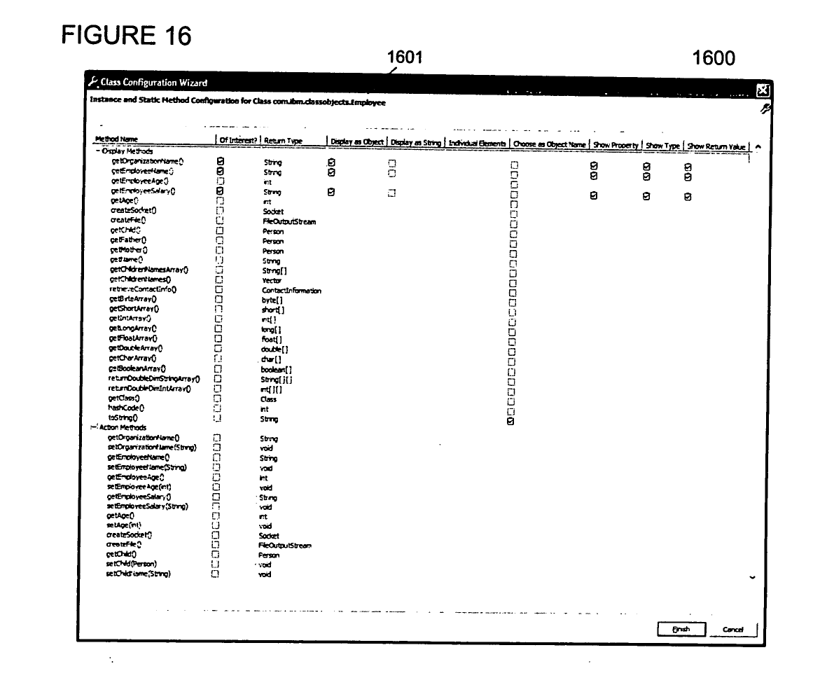

FIG. 13 illustrates 1300 an exemplary view showing that it is possible to save 1301 (and subsequently erase) the current Service Client customization, including the just performed Session Tree configuration. FIG. 14 illustrates 1400 an exemplary configuration in which a service operation called (retrievePerson) 1401 is selected. This operation is used to retrieve personal records and will now be made visible in the Session Tree for each “PeopleDirectory” service. FIG. 15 illustrates an exemplary view 1500 in which the selected operation shown in FIG. 14 has been invoked (e.g., retrievePerson( ) with parameter “Mary” 1501). FIG. 16 illustrates 1600 an exemplary configuration for a different class of objects (or message schema), Employee 1601.

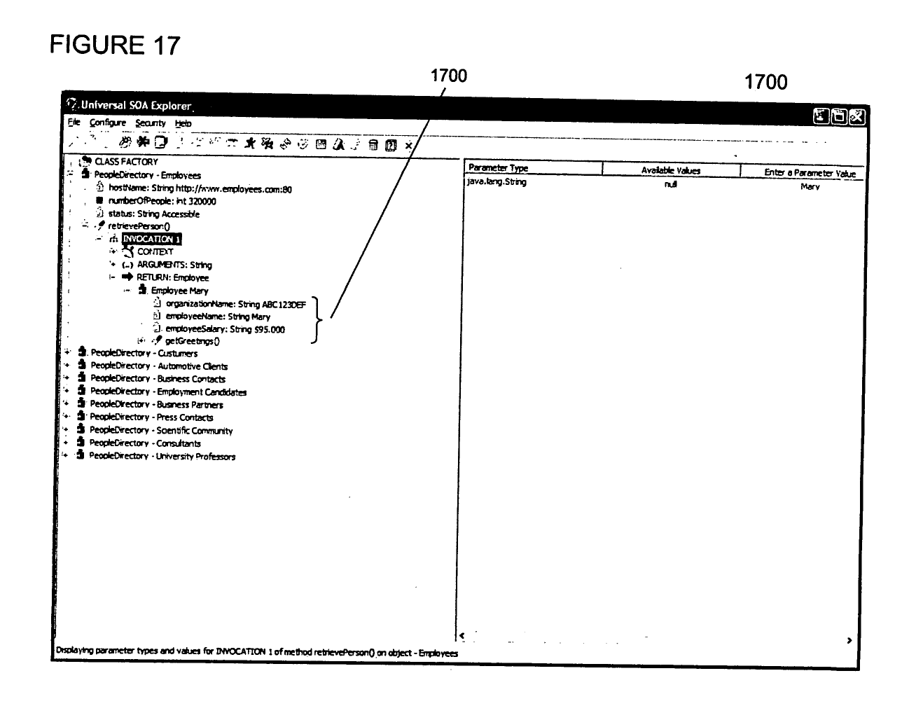

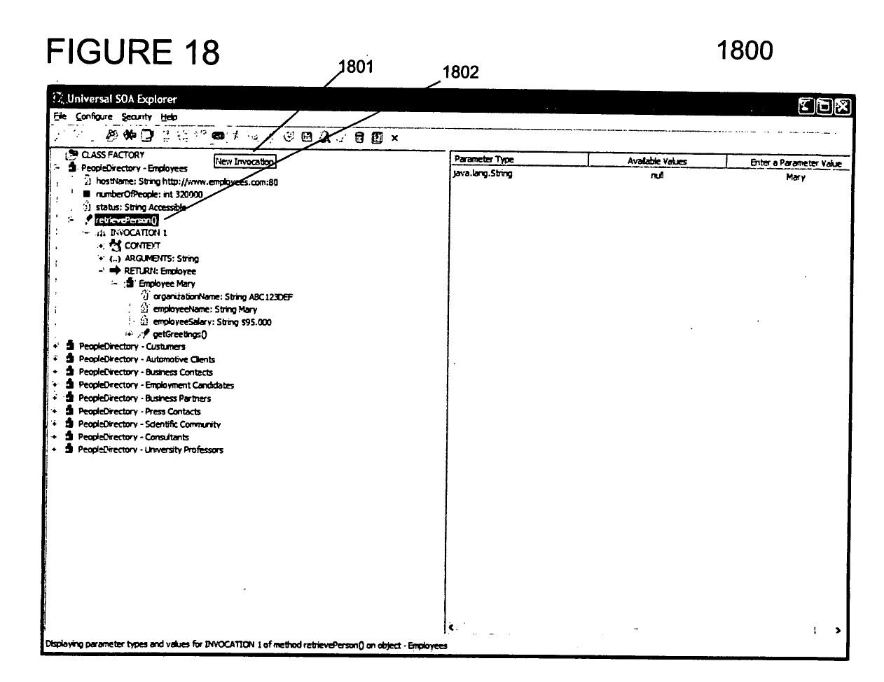

FIG. 17 illustrates an exemplary view 1700 showing that any configuration change is immediately reflected in a hierarchical object tree view 1701. FIG. 18 illustrates 1800 an exemplary view in which a new invocation 1801 for a method 1802 is created.

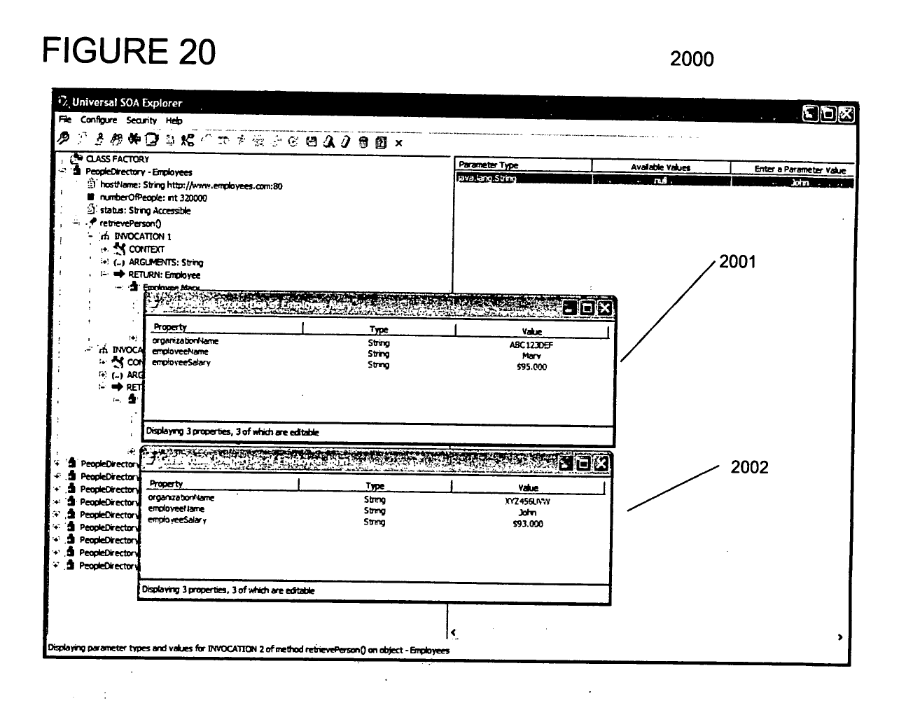

FIG. 19 illustrates an exemplary view 1500 with two different invocations 1501, 1502 for the same operation (in the example, the operation is called retrievePerson 1503). FIG. 20 illustrates an exemplary view 1600 in which the properties of two objects are simultaneously displayed for easy comparison, using the contextual property windows 1601, 1602.

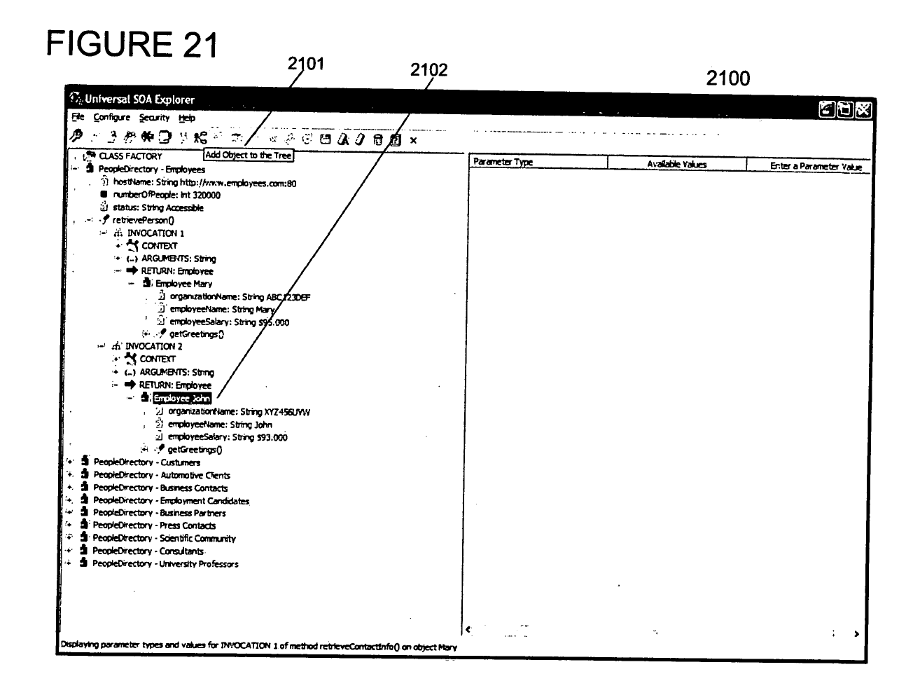

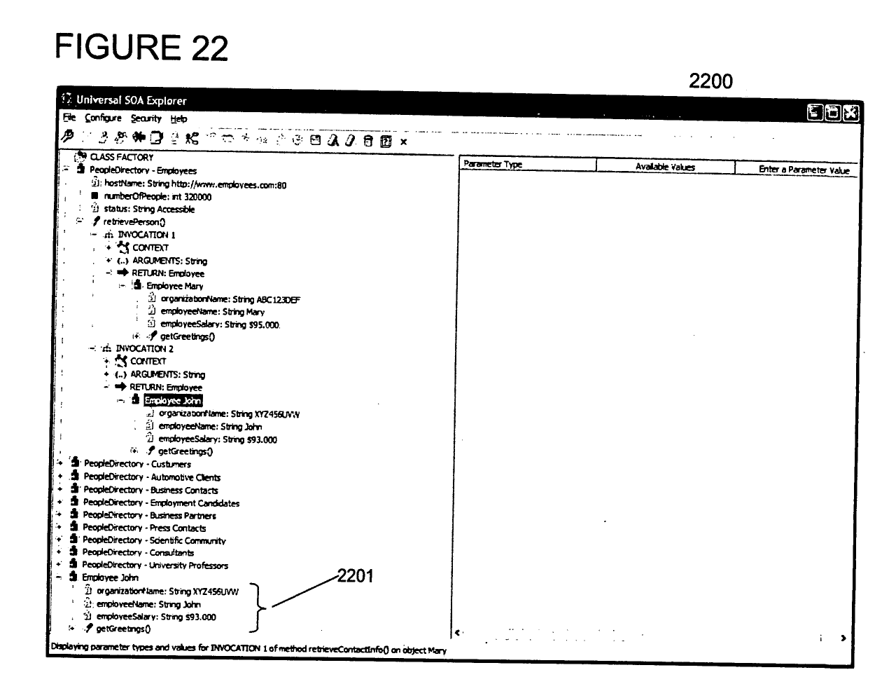

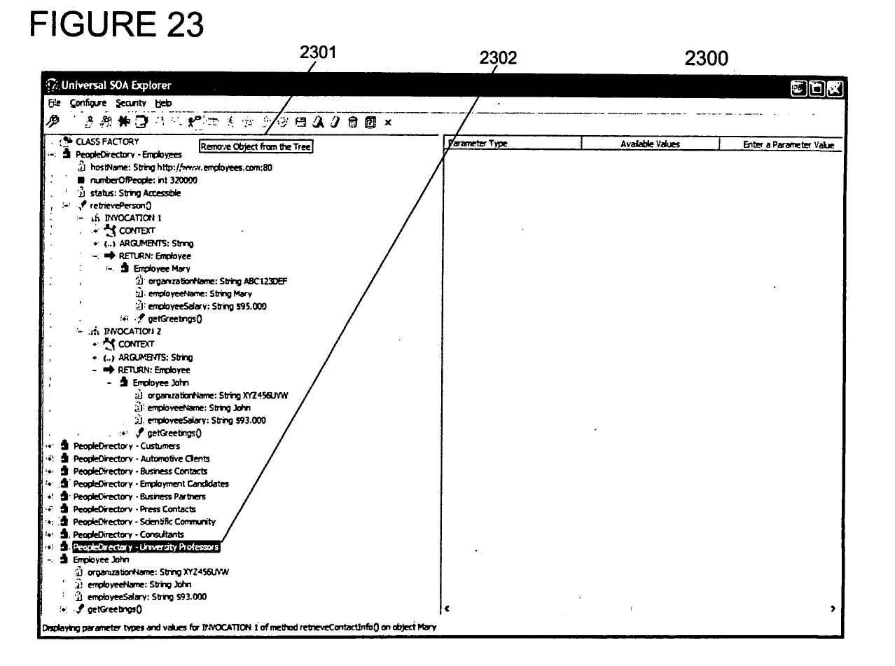

FIG. 21 illustrates an exemplary view 2100 demonstrating that it is possible to move Session Tree nodes and make them roots of the Session Tree 2101. In this case, object Employee John 2102 is being moved to the root of the tree. FIG. 22 illustrates an exemplary view 2200 demonstrating the effect of moving an object and making it become a root of the Session Tree. In this case, object John 2102 from FIG. 17 has been moved to become a root 2201. FIG. 23 illustrates an exemplary view 2300 showing that roots of the Session Tree may be removed 2301, 2302.

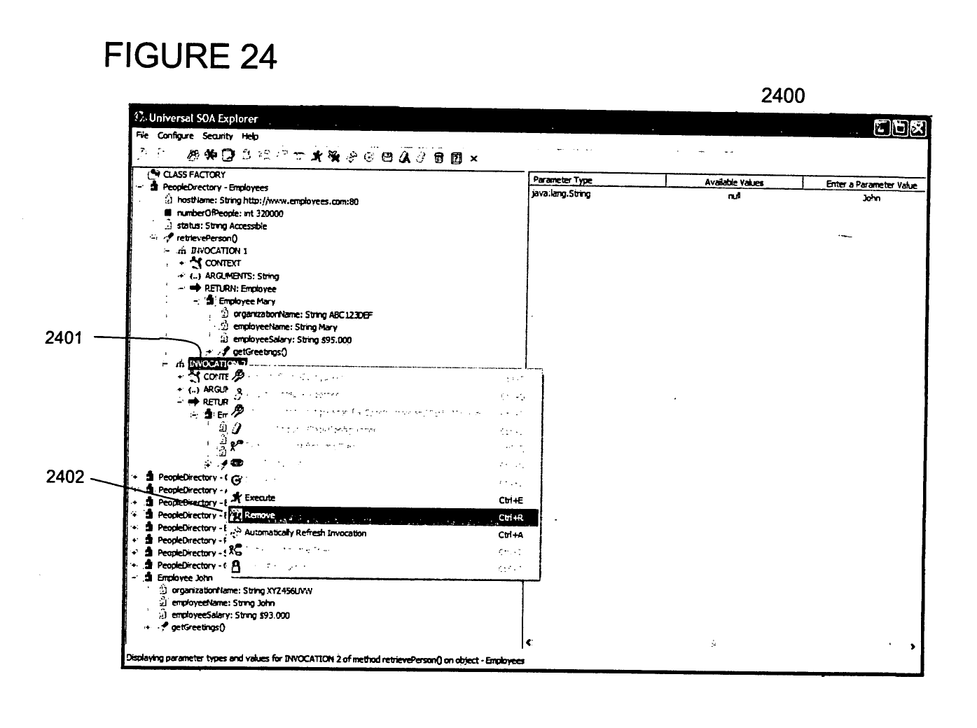

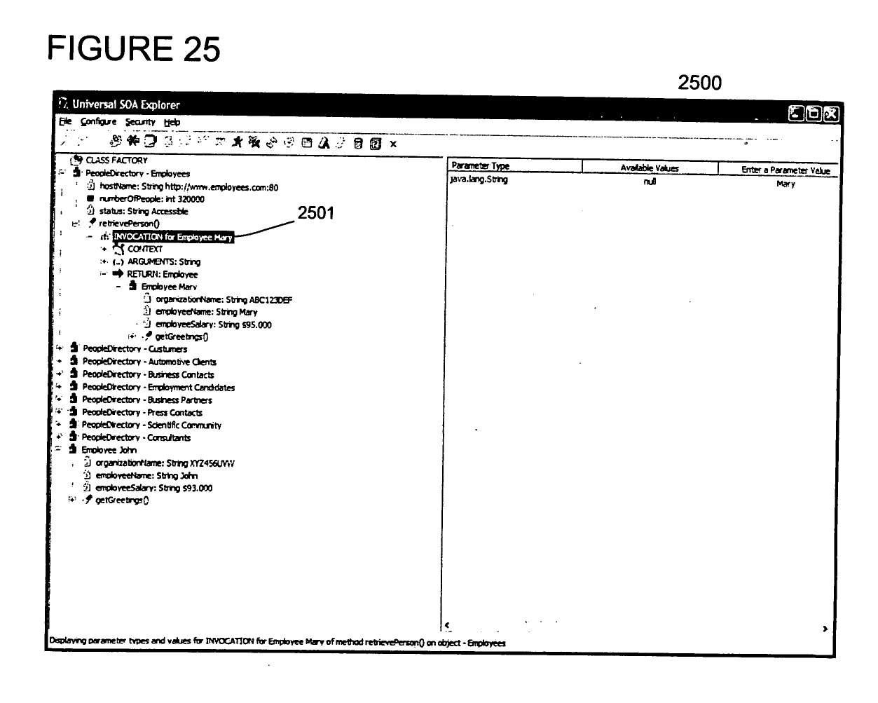

FIG. 24 illustrates 2400 an exemplary configuration showing that past operation invocations may be removed 2401, 2402, and FIG. 25 illustrates 2500 an exemplary configuration showing that invocations 2501 may be renamed (note that previous name “INVOCATION 1” of FIG. 24 is now “INVOCATION for Employee Mary”).

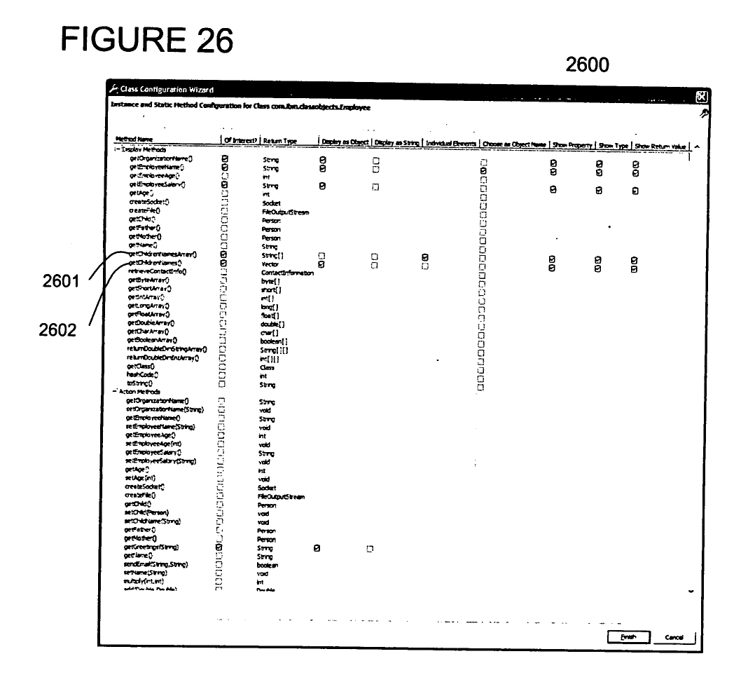

FIG. 26 illustrates 2600 an exemplary configuration showing that if an operation returns an array or a collection of objects (or messages) as output, then it is possible to display the individual elements of the output value, rather than the array of collection itself. In this Class Configuration Wizard, getChildrenNamesArray( ) 2601 and getChildrenNames( ) 2602 have both been selected. Object getChildrenNamesArray( ) 2601 returns an array and its individual elements are going to be displayed in the tree. Object getChildrenNames( ) 2602 returns a vector but, in this case, the vector itself will be displayed in the tree.

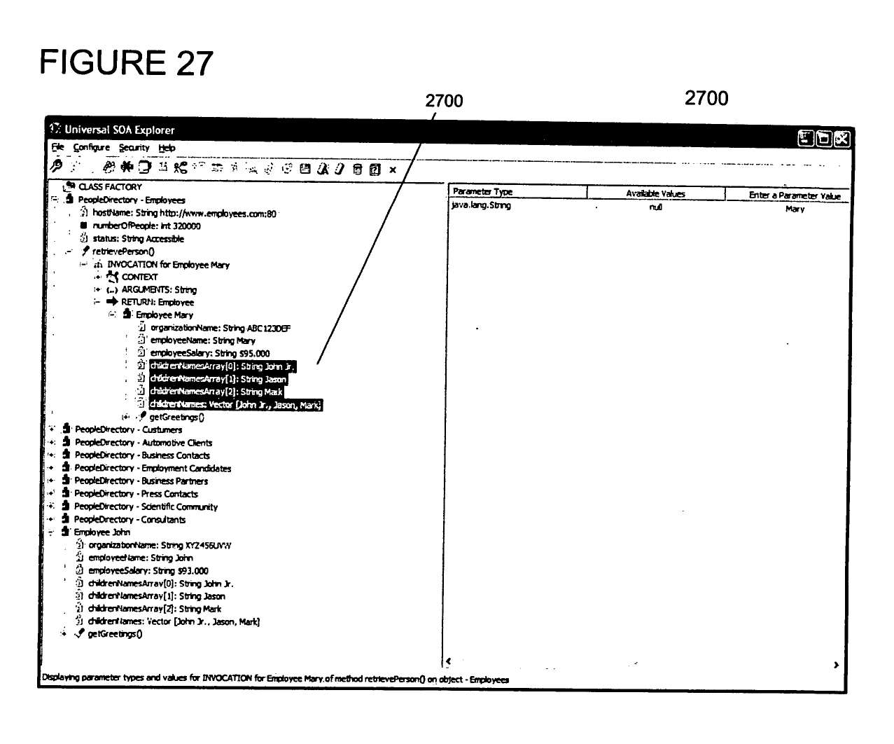

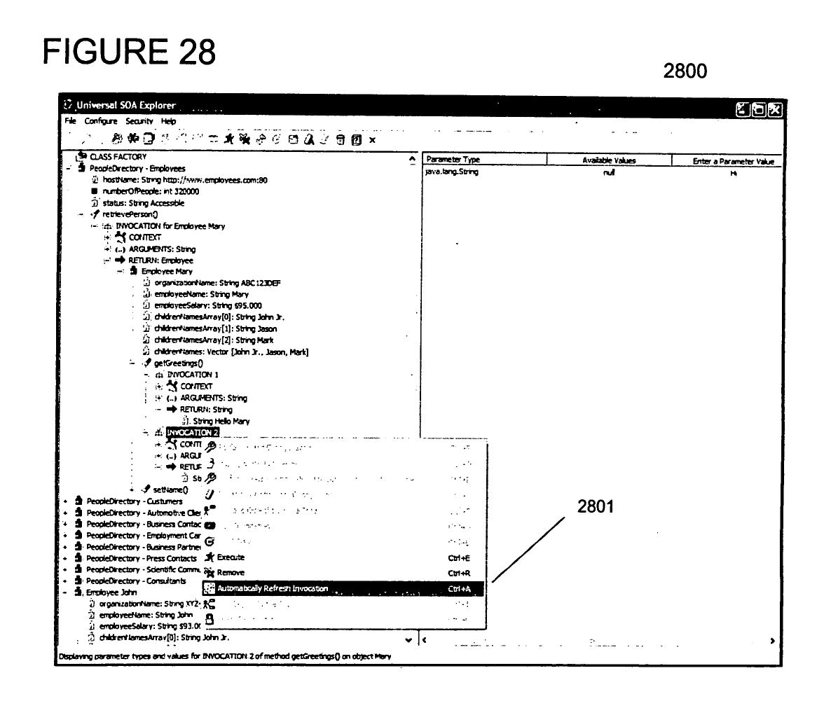

FIG. 27 illustrates an exemplary view 2700 showing how the arrays and collections discussed in FIG. 26 are displayed 2701 in the Session Tree according to the configuration. FIG. 28 illustrates 2800 an exemplary configuration showing that invocations can be automatically refreshed 2801.

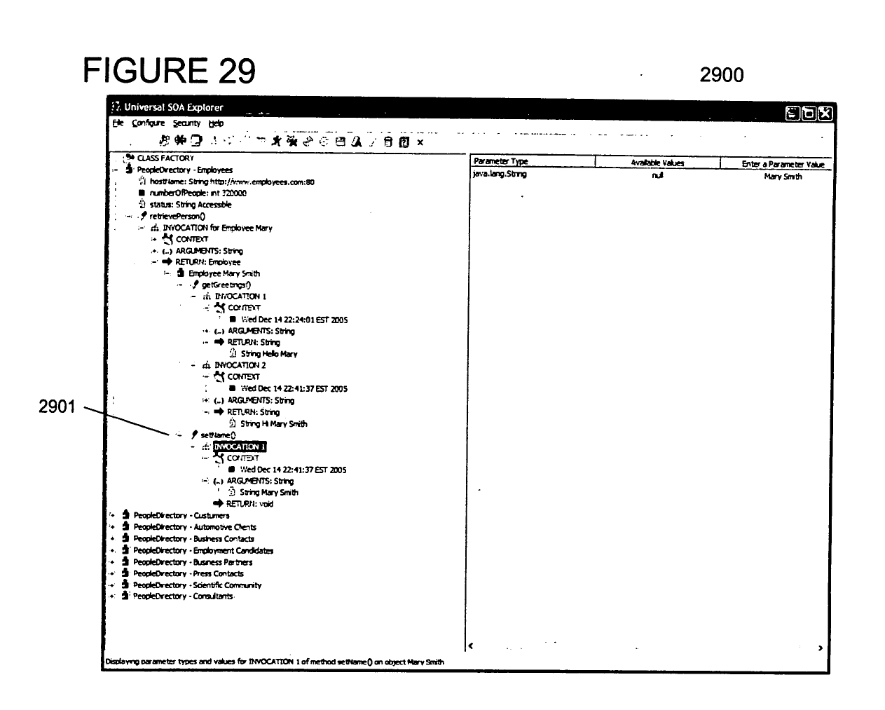

FIG. 29 illustrates an exemplary view 2900 demonstrating the effect of having invocations that are automatically refreshed as opposed to invocations that are manually refreshed. In this example, upon changing the name of the object, from “Mary” to “Mary Smith” by invoking the method setName( ) 2901, the name of the object is automatically updated (from “Employee Mary” to “Employee Mary Smith”). INVOCATION 1 of method getGreetings( ) is not updated and still reports “Hello Mary”. INVOCATION 2 of getGreetings( ) is automatically refreshed and, in fact, it shows the updated return value at the same time as INVOCATION 1 of setName( ).

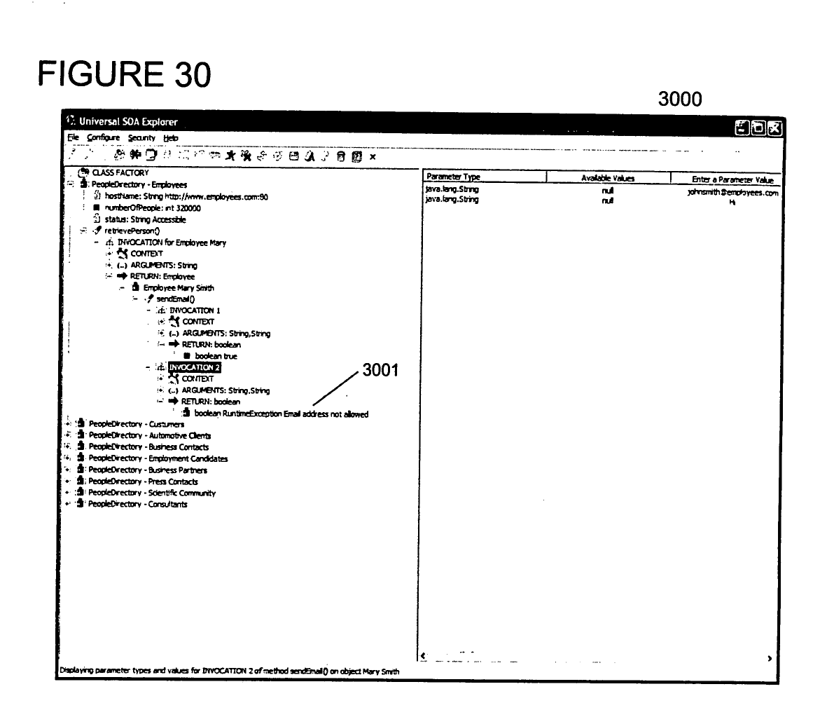

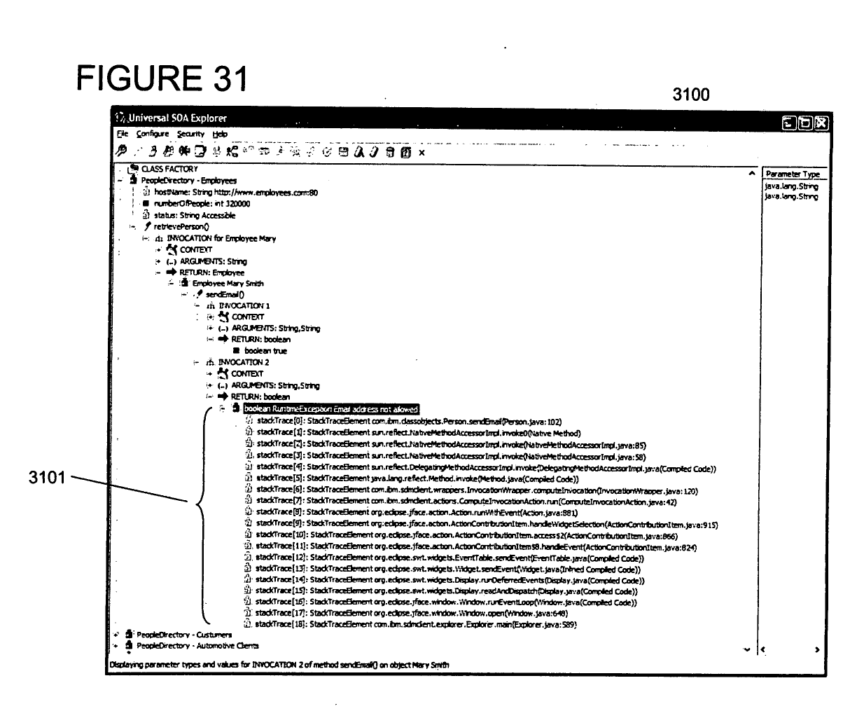

FIG. 30 illustrates an exemplary view demonstrating that any error or exception is reported 3001 without causing the program to stop. FIG. 31 illustrates an exemplary view 3100 showing trace messages resulting from a faulty service operation invocation.

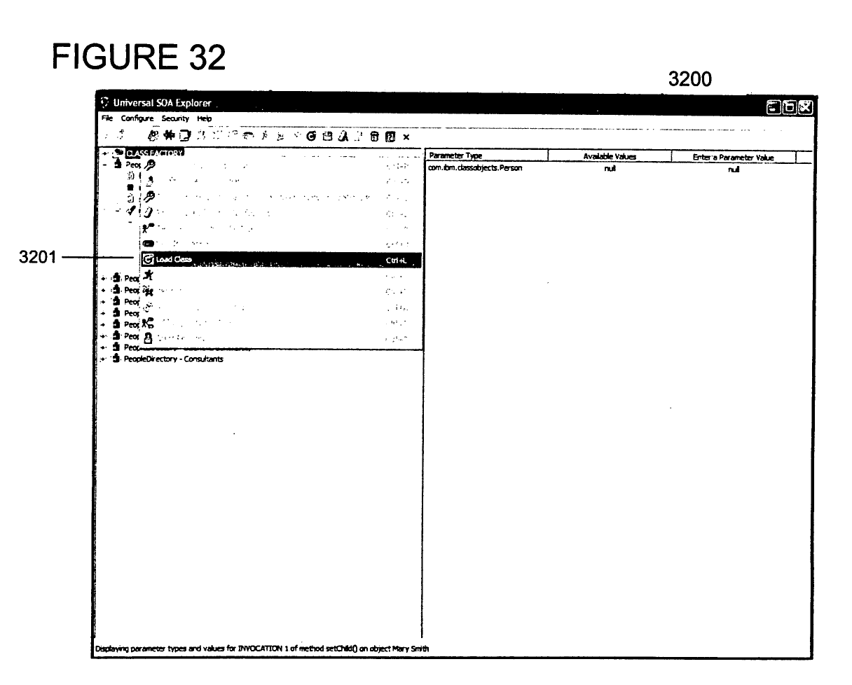

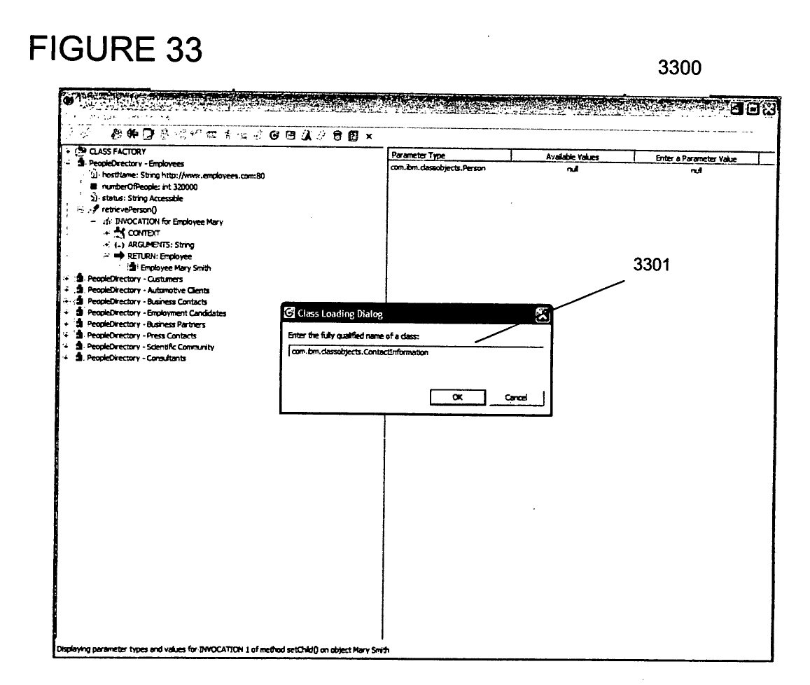

FIG. 32 illustrates 3200 an exemplary configuration demonstrating that, if complex objects (messages) need to be created, loading of new classes (or new schemas) 3201 is possible. FIG. 33 illustrates an exemplary configuration in which the user can specify the name of the class (or schema) 3301 to load.

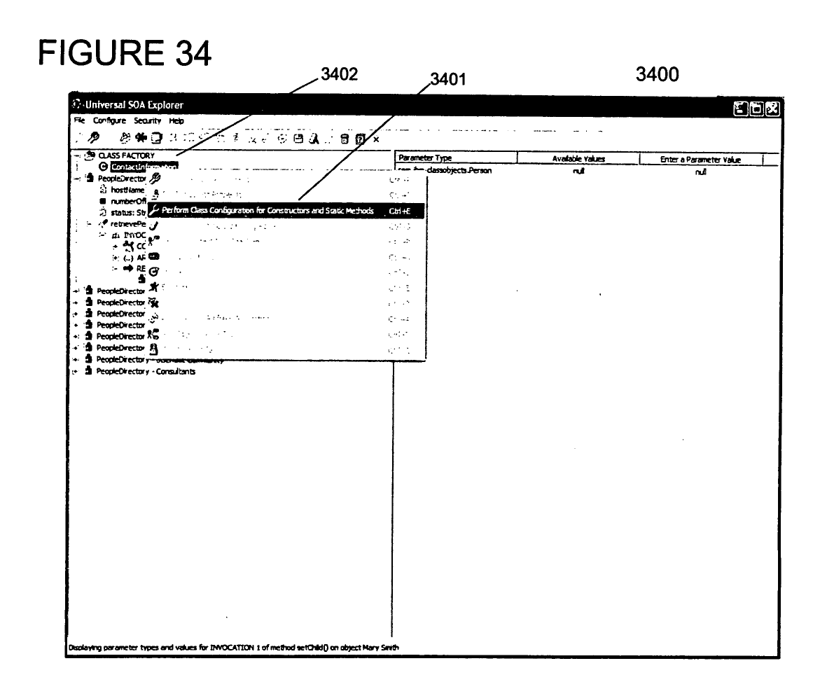

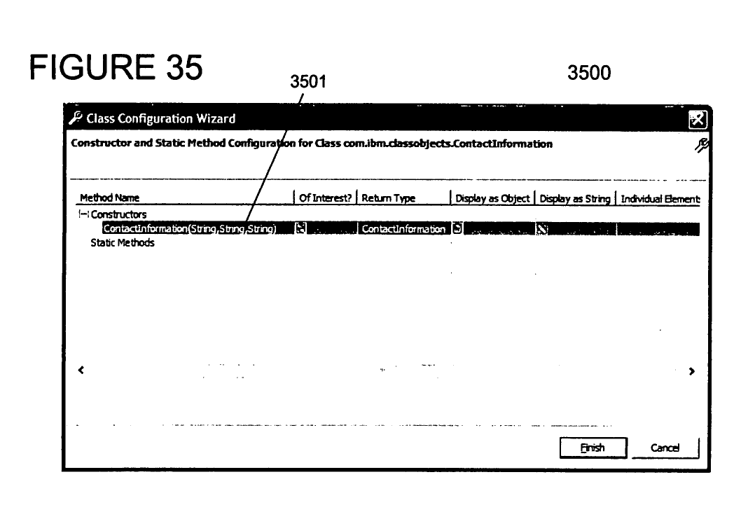

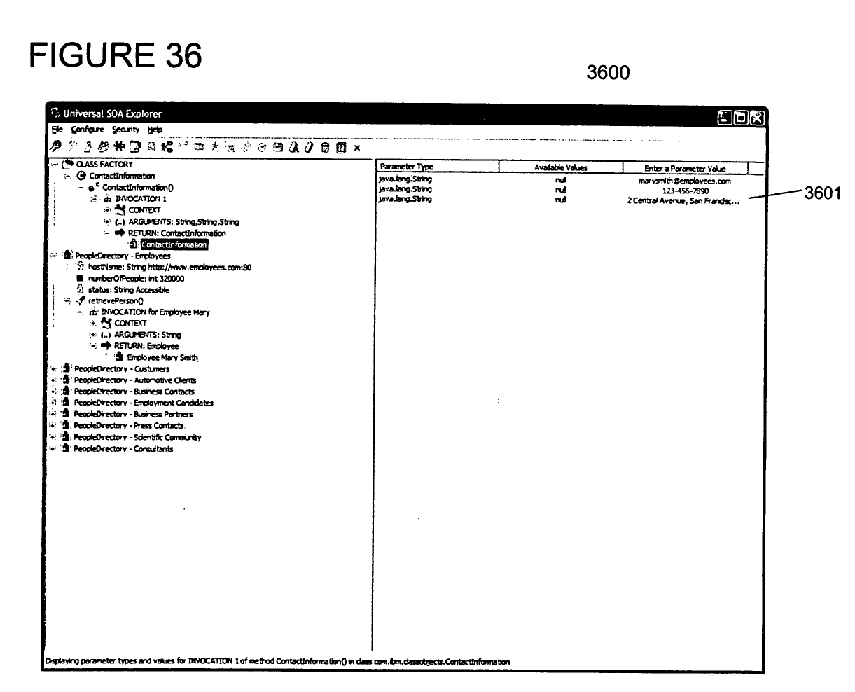

FIGS. 34 and 35 illustrate exemplary views 3400,3500 demonstrating that the visual appearance and interactive features of each loaded class (or schema) may also be configured by clicking on a construction method icon 3401 for the ContactInformation object 3402 to provide the constructor 3501 for the ContactInformation object 3402. FIG. 36 illustrates an exemplary view 3600 showing that objects (or messages) can be created, such as the ContactInformation object 3601.

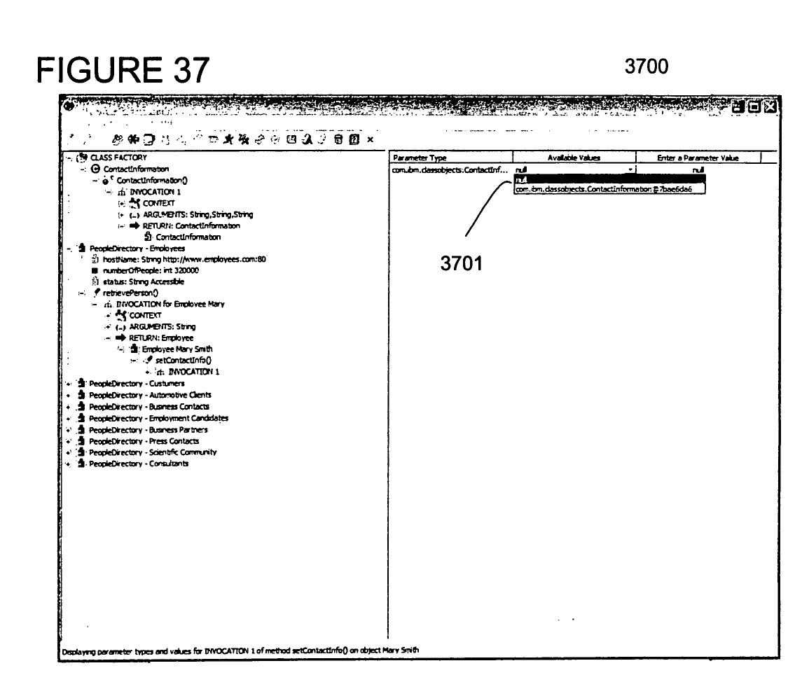

FIG. 37 illustrates an exemplary view 3700 showing that complex objects (or messages) may be used as parameters in new invocations by selecting them in a scroll-down boxes as available values or, alternatively, be dragging and dropping them into the appropriate parameter lines. In this example, the ContactInformation object can now be used a parameter in new invocations. It appears in a scroll-down box 3701 as an available value. Alternatively, it can be dragged and dropped into the parameter line.

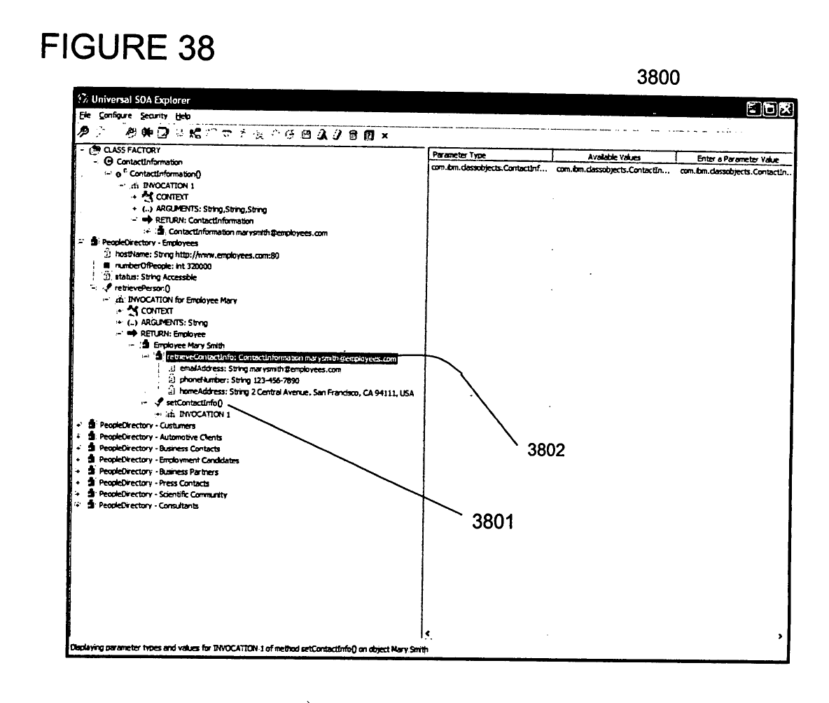

FIG. 38 illustrates an exemplary view 3800 showing that invocations with previously constructed complex objects (messages) are possible. In this case, the method retrieveContactInfo 3801 can now be invoked and the return value 3802 reflects the information previously entered.

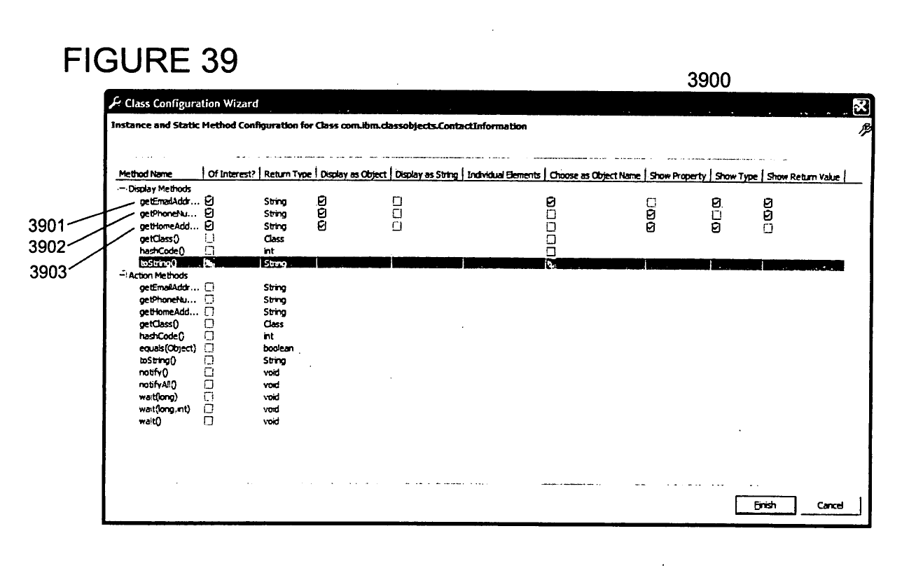

FIG. 39 illustrates 3900 an exemplary configuration showing that the user can select what to display for the return value of every operation as combination of the property name (obtained from the method name), the property type, and the property value. This example Class Configuration Wizard shows different combinations for properties emailAddress 3901, phoneNumber 3902, and homeAddress 3903.

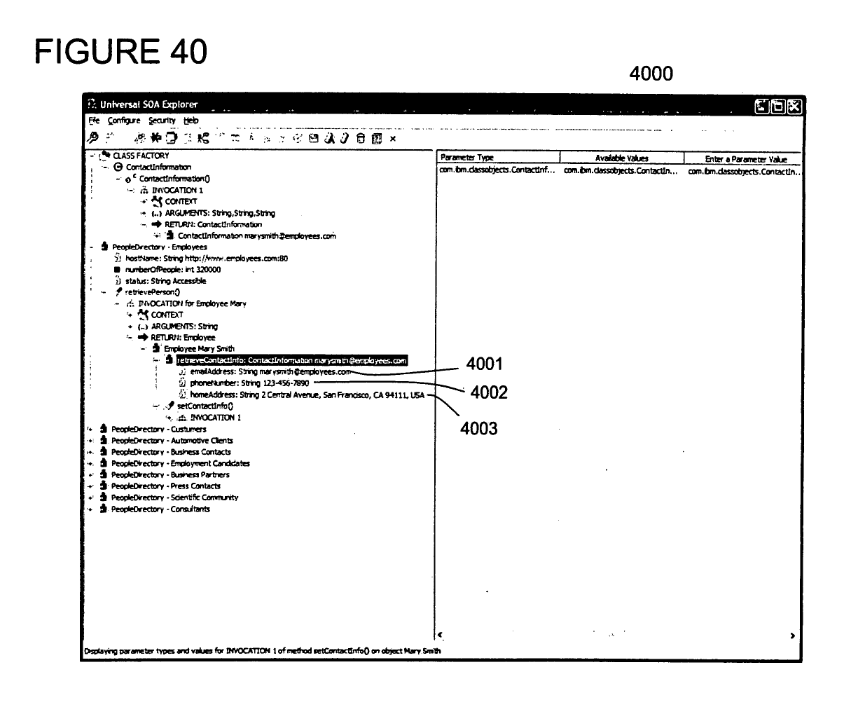

FIG. 40 illustrates an exemplary view 4000 showing that different properties are displayed with different characteristics based on the user's configuration, as the three different properties 4001, 4002, 4003 displayed in different ways in the tree, as based on changes made in the configuration window in FIG. 39.

Typical Hardware Configuration

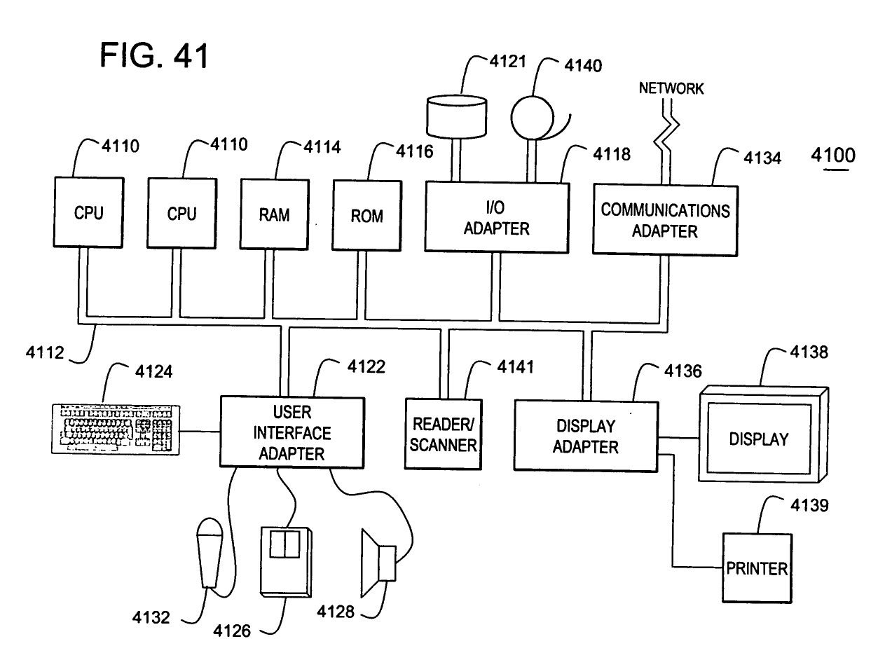

FIG. 41 illustrates a typical hardware configuration which may be used for implementing the computer system and method according to the exemplary aspects of the present invention. The configuration 4100 has preferably at least one processor or central processing unit (CPU) 4111. The CPUs 4111 are interconnected via a system bus 4112 to a random access memory (RAM) 4114, read-only memory (ROM) 4116, input/output (I/O) adapter 4118 (for connecting peripheral devices such as disk units 4121 and tape drives 4140 to the bus 4112), user interface adapter 4122 (for connecting a keyboard 4124, mouse 4126, speaker 4128, microphone 4132, and/or other user interface device to the bus 4112), a communication adapter 4134 for connecting an information handling system to a data processing network, the Internet, and Intranet, a personal area network (PAN), etc., and a display adapter 4136 for connecting the bus 4112 to a display device 4138 and/or printer 4139. Further, an automated reader/scanner 4141 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing media tangibly embodying a program of machine-readable instructions executable by a digital data processor to perform the above method.

Such a method may be implemented, for example, by operating the CPU 4111 to execute a sequence of machine-readable instructions. These instructions may reside in various types of signal bearing media.

Thus, this aspect of the present invention is directed to a programmed product, including signal-bearing media tangibly embodying a program of machine-readable instructions executable by a digital data processor incorporating the CPU 4111 and hardware above, to perform the method of the invention.

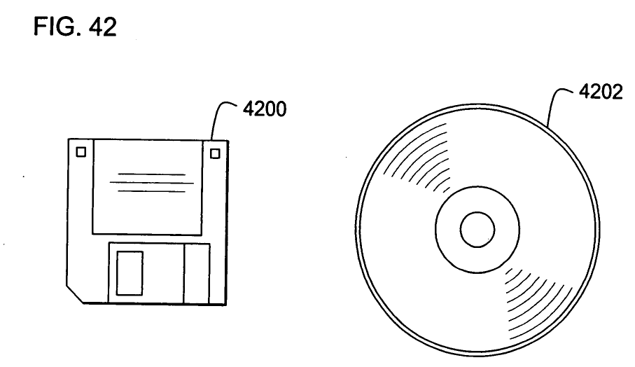

This signal-bearing media may include, for example, a RAM contained within the CPU 4111, as represented by the fast-access storage for example. Alternatively, the instructions may be contained in another signal-bearing media, such as a magnetic data storage diskette 3800 or CD-ROM 4202 (FIG. 42), directly or indirectly accessible by the CPU 4111.

Whether contained in the computer server/CPU 4111, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, complied from a language such as C, C++, etc.

While the invention has been described in terms of one or more exemplary embodiments, those skilled in the art will recognize that the invention can be practiced with modification within the spirit and scope of the appended claims. Specifically, one of ordinary skill in the art will understand that the drawings herein are meant to be illustrative, and the design of the inventive assembly is not limited to that disclosed herein but may be modified within the spirit and scope of the present invention.

Further, Applicants' intent is to encompass the equivalents of all claim elements, and no amendment to any claim the present application should be construed as a disclaimer of any interest in or right to an equivalent of any element or feature of the amended claim.

What is claimed is:

1. A computer-implemented method for creating a service client for a service and a role, said method comprising:
exercising an application programming interface (API) of the service to perform activities of the role;
discovering data and behavioral models exposed by the service during this exercise; and
configuring a selected set of graphical user interface (GUI) components to represent the discovered data and behavioral models for the activities of the role.

2. The computer-implemented method according to claim 1, wherein the discovering the data and behavioral models exposed by the service comprises discovering exact types of objects or exact schemas of messages returned by service operations.

3. The computer-implemented method according to claim 1, wherein the discovering the data and behavioral models exposed by the service comprises discovering using API inspection mechanisms including at least one of reflection and introspection.

4. The computer-implemented method according to claim 1, wherein the configuring a selected set of GUI components comprises:
selecting a set of GUI components appropriate to represent the discovered data and behavioral models;
laying out geometrically these GUI components; and
configuring each GUI component individually.

5. The computer-implemented method according to claim 1, wherein the set of GUI components comprises at least one interactive graph of visual nodes representing at least one of a service data model and a service behavioral model.

6. The computer-implemented method according to claim 1, wherein an execution of an application is represented as a Functional Invocation Tree (FIT) providing a graphical representation of functional dependencies and relations between objects in the application.

7. The computer-implemented method according to claim 4, wherein the configuring comprises a customizing of one or more of:
which operations of a service should be invoked; and
which information about operation inputs and outputs should be displayed.

8. The computer-implemented method according to claim 5, wherein the at least one of a service data model and a service behavioral model is represented as a configurable tree of interactive objects.

9. The computer-implemented method according to claim 1, wherein the service is represented as a tree having children objects that represent either properties or operations of the service, said children objects representing service operations being interactive so that said service operations can be invoked by a user input.

10. The computer-implemented method according to claim 9, wherein a service operation may be invoked multiple times, each invocation being represented as a child object of the operation.

11. The computer-implemented method according to claim 9, wherein a hierarchy of service operation and operation invocations is represented as a tree that captures all the actions performed by a user during a session, as well as their outcome.

12. The computer-implemented method according to claim 11, wherein the tree is customized on a per object class basis (or per schema basis), meaning that all objects of a common class (or all messages of a common schema) share a same individual customization and have a same appearance and interactive behavior.

13. A programmable storage medium tangibly embodying a program of machine-readable instructions executable by a digital processing apparatus to permit a user in a customizer role to perform the method of creating a graphical user interface in accordance with claim 1.

14. A system for creating a graphical user interface of a target remote software application for a target user role, said system comprising:
a software module of instructions providing a user interface so that a user serving as a customization role can:
exercise an application programming interface of the target remote software application to perform activities of the target user role;
discover data and behavioral models exposed by the target remote software application during this exercise; and
configure a selected set of graphical user interface components to represent the discovered data and behavioral models for the activities of the target user role.

15. The system of claim 14, wherein the customization role configures the selected set of GUI components by:
selecting a set of GUI components appropriate to represent the discovered data and behavioral models;
laying out geometrically these GUI components; and
configuring each GUI component individually.

16. The system of claim 15, further comprising:
a memory to store a result of the customization role to be invoked as a graphical user interface by an end-user serving as the target user role of the target remote software application.

17. The system of claim 14, wherein said software module of instructions comprises code written in Java.
